(19) United States
(12) Patent Application Publication
(10) Pub. No.: US 2014/0204228 A1
(43) Pub. Date: Jul. 24, 2014

(54) INFORMATION PROCESSING DEVICE, INFORMATION PROCESSING METHOD, AND IMAGING DEVICE

(71) Applicant: Sony Corporation, Tokyo (JP)

(72) Inventors: Masatoshi YOKOKAWA, Kanagawa (JP); Takefumi NAGUMO, Kanagawa (JP)

(73) Assignee: Sony Corporation, Tokyo (JP)

(21) Appl. No.: 14/095,153

(22) Filed: Dec. 3, 2013

(30) Foreign Application Priority Data
Jan. 23, 2013 (JP) 2013-010244

(51) Int. Cl. H04N 5/232

(52) U.S. Cl. CPC H04N 5/23267
USPC 348/208.6

(57) ABSTRACT

An amplification detection unit detects an amplification of a motion of an image in a motion correction with respect to the motion of the image generated by the motion, according to motion information which indicates a motion detection result and a frame rate of the image. An information suppressing unit suppresses the motion indicated by the motion information based on the detection result of the amplification detection unit such that the motion of the image is not amplified in the motion correction, and generates corrected motion information used in the motion correction.

### CROSS REFERENCE TO RELATED APPLICATIONS

This application claims the benefit of Japanese Priority Patent Application JP 2013-010244 filed Jan. 23, 2013, the entire contents of which are incorporated herein by reference.

### BACKGROUND

The present technology relates to an information processing device, an information processing method, and an imaging device that can improve a performance of a motion correction.

In an imaging device in the related art, by detecting a camera shake at the time of imaging by a motion detection unit such as an angular velocity sensor, and based on the detection result, by moving an optical system and an imaging element such that the detected camera shake is cancelled, a correction of a shake of an optical image formed on the imaging surface of the imaging element is performed.

In addition, in Japanese Unexamined Patent Application Publication No. 2007-074360, an image blur due to the motion of the imaging device at the time when a shutter button is pressed and a captured image is acquired is calculated based on the motion detection result, and the correction of the calculated image blur is performed.

### SUMMARY

Incidentally, in a case where an image blur of the captured image is corrected based on a motion detection result, if the time difference between the motion detection and an acquisition of the captured image is short enough, the motion detection result indicates the motion at the time point of capturing the image more correctly, thus, the image blur can be corrected more accurately. However, if the time difference between the motion detection and the acquisition of the captured image is large, the motion detection result and the motion at time point of capturing the image are different from each other, thus, there is a concern that the performance of the motion correction, that is, the image blur correction may deteriorate.

Therefore, in the present technology, it is desirable to provide an information processing device, an information processing method, and an imaging device that can improve the performance of motion correction.

According to an embodiment of the present technology, there is provided an information processing device that includes an amplification detection unit that detects an amplification of a motion of an image in a motion correction with respect to the motion of the image generated by the motion, according to motion information which indicates a motion detection result and a frame rate of the image; and an information suppressing unit that suppresses the motion indicated by the motion information based on the detection result of the amplification detection unit such that the motion of the image is not amplified in the motion correction, and generates corrected motion information used in the motion correction.

In this technology, the amplification of the motion of the image in the motion correction with respect to the motion of the image generated by the motion, according to the motion information which indicates the motion detection result and the frame rate of the image, is detected. For example, in a case where the motion of the image caused by the shake of the imaging device is corrected according to the motion information which indicates the shake of the imaging device and the frame rate of the image generated by the imaging device, by calculating a stability rate which indicates a proportion of a component which amplifies the motion of the image in the motion correction, and by converting the stability rate to a correction rate of the motion information to be used as a detection result. The stability rate, for example, is calculated based on the motion information corresponding to a predetermined number of frames and the component which amplifies the motion of the image extracted from the motion information or the component which does not amplify the motion of the image. In addition, correction characteristics of the motion correction can be switched by switching conversion characteristics in which the stability rate is converted to the correction rate. For example, in a case where the amplification suppression of the motion of the image is emphasized in the motion correction, the conversion characteristics are set to be such that, in the interval where the stability rate is low, the correction rate interval in which the state where the shake correction is not performed is longer than that in a case where the correction accuracy is emphasized. The suppression of the motion information based on the correction rate obtained in this way, the motion correction is performed using the suppressed motion information.

In addition, a motion prediction is performed using the motion information, and then the motion prediction information is generated. In the motion prediction, one or a plurality of different prediction models are used. In a case where a prediction error of motion prediction information is smaller than a threshold value set in advance, motion prediction information is used as the corrected motion information, and in a case where the prediction error is equal to larger than the threshold value set in advance, the suppressed motion information is used as the corrected motion information. Then the motion correction is performed using the corrected motion information. Furthermore, in a case where a plurality of different prediction models are used, and in a case where a minimum prediction error is smaller than the threshold value set in advance, the motion prediction information obtained by using a prediction model having the minimum prediction error is used as the corrected motion information. In addition, in the motion detection unit that generates the motion information, a time difference between the image in which the motion correction is performed and the motion detection is reduced by generating the motion information using a part of the image.

According to another embodiment of the present technology, there is provided an information processing method that includes: detecting an amplification of a motion of an image in a motion correction with respect to the motion of the image generated by the motion, according to motion information which indicates a motion detection result and a frame rate of the image; and suppressing the motion indicated by the motion information based on the detection result such that the motion of the image is not amplified in the motion correction, and generating corrected motion information used in the motion correction.

According to still another embodiment of the present technology, there is provided an imaging device including: an imaging unit that generates an image signal of a captured image; a motion detection unit that detects the motion of the device and generates motion information; an amplification detection unit that detects an amplification of a motion of an image in a motion correction with respect to the motion of the image generated by the motion of the device, according to motion information a frame rate of the image; an information suppressing unit that suppresses the motion indicated by the motion information based on the detection result of the amplification detection unit such that the motion of the image is not amplified in the motion correction, and generates corrected motion information used in the motion correction; and a correction unit that performs the motion correction of the captured image based on the corrected motion information generated by the information suppressing unit.

According to the present technology, an amplification of a motion of an image in a motion correction with respect to the motion of the image generated by the motion is detected according to motion information which indicates a motion detection result and a frame rate of the image. In addition, the motion indicated by the motion information based on the detection result of the amplification detection unit such that the motion of the image is not amplified in the motion correction is suppressed, and then corrected motion information used in the motion correction is generated. Therefore, by performing the motion correction based on the corrected motion information, for example, since the image blur can be prevented from increasing in the shake correction, it is possible to improve the performance of the motion correction.

### BRIEF DESCRIPTION OF THE DRAWINGS

FIG. 1 is a diagram illustrating a relationship between a shake frequency and an amplitude amplification rate after a shake correction;

FIGS. 2A and 2B are diagrams illustrating amplitude of the shake before and after the shake correction (in a case where the shake frequency is low);

FIGS. 3A and 3B are diagrams illustrating amplitude of the shake before and after the shake correction (in a case where the shake frequency is high);

FIG. 4 is a diagram illustrating a configuration of an imaging device using an information processing device according to the present technology;

FIG. 5 is a diagram illustrating a configuration of a shake correction control unit in a first embodiment;

FIG. 6 is a flowchart illustrating an example of a shake correction operation;

FIG. 7 is a diagram illustrating a first configuration of a suppression processing unit;

FIGS. 8A to 8C are diagrams illustrating conversion characteristics in case of converting a stability rate to a correction rate;

FIG. 9 is a diagram illustrating a configuration of an amplification detection unit;

FIG. 10 is a diagram illustrating a modification example of the amplification detection unit;

FIG. 11 is a diagram illustrating a modification example of the amplification detection unit;

FIG. 12 is a diagram illustrating a modification example of the amplification detection unit;

FIG. 13 is a diagram illustrating a relationship between a shake frequency and an amplitude amplification rate after the shake correction in a case where a suppression processing unit is provided;

FIG. 14 is a diagram illustrating a second configuration of a suppression processing unit;

FIG. 15 is a diagram illustrating a third configuration of a suppression processing unit;

FIG. 16 is a diagram illustrating a configuration of a shake correction control unit in a second embodiment;

FIG. 17 is a flowchart illustrating a shake correction operation in the second embodiment;

FIG. 18 is a diagram for describing a polynomial approximation model;

FIG. 19 is a diagram for describing an autoregressive model;

FIG. 20 is a diagram illustrating a first configuration of a prediction determination unit;

FIG. 21 is a diagram illustrating a timing of a motion detection result, a motion prediction result and shake correction (in case of time delay of one frame);

FIG. 22 is a diagram illustrating a timing of a motion detection result, a motion prediction result and shake correction (in case of time delay of 0.5 frame);

FIG. 23 is a diagram illustrating a relationship between the shake frequency and the amplitude amplification rate after the shake correction when the shake correction is performed using the motion prediction result;

FIG. 24 is a diagram illustrating a second configuration of a prediction determination unit;

FIG. 25 is a flowchart illustrating an operation in case of using a plurality of motion predictions;

FIG. 26 is a diagram illustrating a relationship between the shake frequency and the amplitude amplification rate after the shake correction in a case where the shake correction is performed using the motion prediction result and the suppression processing;

FIG. 27 is a diagram illustrating a configuration of an imaging device using a motion detection sensor; and

FIG. 28 is a diagram for describing a case of suppressing a reverse correction by shortening the delay time.

### DETAILED DESCRIPTION OF EMBODIMENTS

Hereinafter, embodiments for implementing the present technology will be described. The description will be made in order as follows.

1. Regarding deterioration of motion correction performance

2. Configuration of imaging device

3. First embodiment

3-1. Configuration in first embodiment

3-2. Operation in first embodiment

3-3. First configuration and operation of suppression processing unit

3-3-1. Configuration and operation of amplification detection unit

3-3-2. Modification example of amplification detection unit

3-4. Second configuration of suppression processing unit

3-5. Third configuration of suppression processing unit

4. Second embodiment

4-1. Configuration in second embodiment

4-2. Operation in second embodiment

4-3. Regarding motion prediction

4-4. First configuration and operation of prediction determination unit

4-5. Second configuration and operation of prediction determination unit

5. Other embodiments

### 1. Regarding Deterioration of Motion Correction Performance

When the time difference between the motion detection and the acquisition of the captured image is large, a difference between the motion detection result and the motion at time point of capturing the image becomes large, there is a concern that the performance of the motion correction may deteriorate.

A motion vector MVh(x) at time x detected by the motion detection is modeled by a sine wave as illustrated in Equation (1). In Equation (1), “Fi” is a sampling frequency of the motion detection, “Fh” is a frequency of the detected motion. In case of modeling like this, an effect of the motion correction can be illustrated as Equation (2). Moreover, when the motion detection is performed for each frame, Equation (2) illustrates the case where a cumulative amount of motion vector “VA” from a frame “P0” to a frame “Pt” is corrected to “VA−(VB+VC)” using a cumulative amount of motion vector “VB” from a frame “P0” to a frame “P(t−1)” and a cumulative amount of one frame delayed motion vector “VC” (=MVh(t−1)). In addition, a calculated value from Equation (2) is an amplitude amplification rate after the motion correction.

$$\begin{matrix}{MV}_{h} ( t ) = sin ( 2 π \frac{{F}_{h}}{{F}_{i}} \cdot t ) & ( 1 ) \\ \frac{Amplitude after correction}{Amplitude before correction} = \frac{2 sin ( π \cdot \frac{{F}_{h}}{{F}_{i}} )}{\frac{1}{2 sin ( π \cdot \frac{{F}_{h}}{{F}_{i}} )}} = 4 {sin}^{2} ( π \cdot \frac{{F}_{h}}{{F}_{i}} ) & ( 2 )\end{matrix}$$

Accordingly, for example, in a case where the correction of the camera shake and the like is performed, under the condition that the amplitude amplification rate after the shake correction is smaller than “1”, it is possible to reduce an image blur by performing the shake correction. However, under the condition that the amplitude amplification rate after the shake correction is larger than “1”, the image blur may be increased by performing the shake correction. In addition, Equation (3) illustrates a boundary condition under which the image blur is either increased or reduced by performing the shake correction.

$$4 {sin}^{2} ( π \cdot \frac{{F}_{h}}{{F}_{i}} ) = 1 \qquad ( 3 )$$

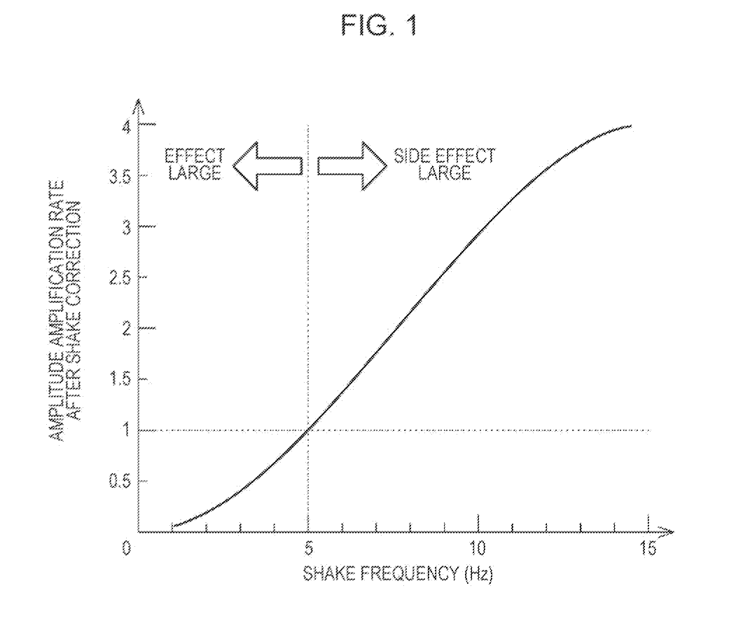

FIG. 1 illustrates a relationship between a shake frequency in a case where the frame rate of the captured image is 30 frames/second and the time difference between the motion detection and the acquisition of captured image is one frame period, and the amplitude amplification rate after a shake correction. In this case, when the shake frequency is lower than 5 Hz, the amplitude amplification rate after the shake correction is smaller than “1”. Therefore, by performing the shake correction based on motion information indicating the motion detection result such as motion detection vector, the image blur can be reduced. The effect of the shake correction decreases along with the shake frequency approaching near to 5 Hz. When the amplitude amplification rate after the shake correction becomes “1” at 5 Hz, the effect of the shake correction is eliminated. In addition, the shake frequency becomes so high as to exceed 5 Hz, the amplitude amplification rate after the shake correction becomes larger than “1”, the image blur is increased by the shake correction and then side effects are increased. In the description hereinafter, the case where the image blur is increased by the shake correction is called “reverse correction”.

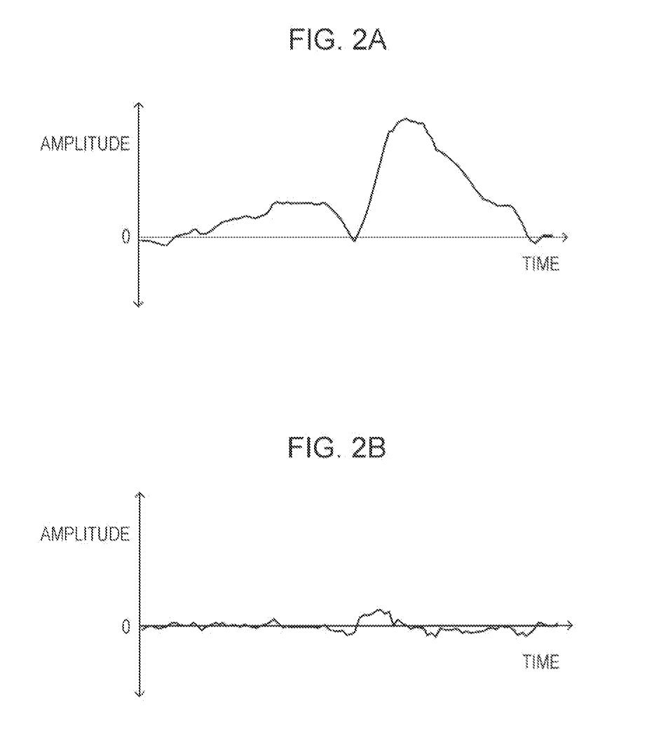

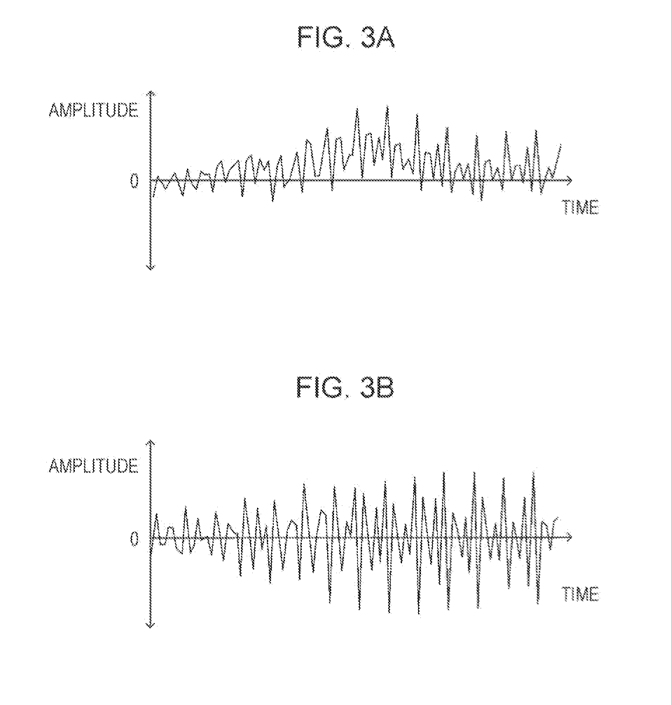

FIGS. 2A, 2B and FIGS. 3A, 3B illustrate the amplitude of the shake before and after the correction. As illustrated in FIGS. 2A and 2B, in a case where the shake frequency is low, by performing the shake correction based on the motion detection result with respect to the shake illustrated in FIG. 2A, it is possible to decrease the amplitude as illustrated in FIG. 2B. However, as illustrated in FIGS. 3A and 3B, in a case where the shake frequency is high, when the shake correction is performed based on the motion detection result with respect to the shake illustrated in FIG. 3A, the amplitude becomes larger than that of before the correction as illustrated in FIG. 3B, that is, the reverse correction.

Therefore, in the information processing device and the information processing method in the present technology, according to the motion information indicating the motion detection result and the frame rate of the image, the amplification of the motion on the image in the motion correction with respect to the motion on the image occurred due to the motion is detected. In addition, according to the detection result, by generating corrected motion information by suppressing the motion in the motion information in such a manner that the motion is not amplified during the motion correction, and then by performing motion correction using such corrected motion information, the reverse correction can be prevented from being performed.

### 2. Configuration of Imaging Device

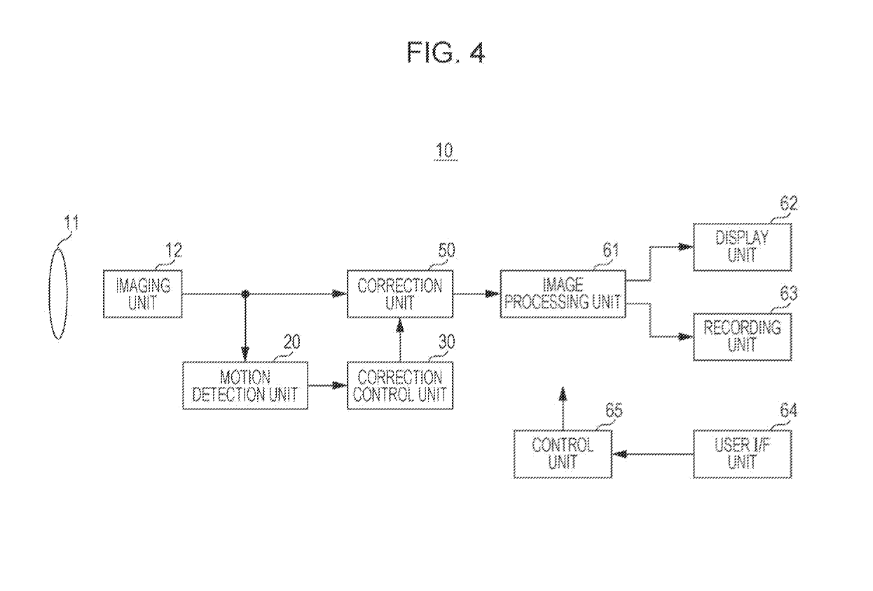

FIG. 4 is a diagram illustrating a configuration of an imaging device using the information processing device according to the present technology. The imaging device 10 includes an imaging optical system 11, an imaging unit 12, a motion detection unit 20, a correction control unit 30, and a correction unit 50. Furthermore, the imaging device 10 includes an image processing unit 61, a display unit 62, a recording unit 63, a user interface (I/F) unit 64, and a control unit 65.

The imaging optical system 11 is configured to have a focus lens or a zoom lens, and the like. In the imaging optical system 11, for example, a focus adjustment is performed by moving the focus lens in an optical axis direction. In addition, a focal length can be varied by moving the zoom lens in the optical axis direction.

The imaging unit 12 is configured to include an imaging element, a pre-processing unit, and an imaging drive unit, and the like. The imaging element performs a photoelectric conversion process to convert the optical image formed on the imaging surface by the imaging optical system 11 into an electric signal. For example, a charge coupled device (CCD) image sensor or a complementary metal oxide semiconductor (CMOS) image sensor is used as the imaging element. The pre-processing unit performs a noise removing process such as a correlated double sampling (CDS) with respect to the electric signal generated in the imaging element. In addition, the pre-processing unit performs a gain adjustment to make the electric signal level a desired signal level. Furthermore, the pre-processing unit performs an A/D conversion process to convert the electric signal in which the noise is removed and the gain adjustment is performed into a digital signal, and output the digital image signal to the motion detection unit 20 and the correction unit 50. The imaging drive unit performs a generation of an operation pulse and the like necessary for driving the imaging element based on the control signal from the control unit 65 described later. For example, the imaging drive unit performs a generation of a charge readout pulse for reading out a charge, a transmission pulse for performing a transmission in a vertical or horizontal direction, and a shutter pulse for performing an electronic shutter operation.

The motion detection unit 20 performs the motion detection using the image signal supplied from the imaging unit 12, and generates the motion detection vector indicating the shake of the imaging device 10 as motion information. The motion detection unit 20 calculates a global motion vector, and outputs the calculated global motion vector to the correction control unit 30 as a motion detection vector.

The correction control unit 30 detects the amplification of the image blur in the shake correction of the motion on the image occurred by the shake of the imaging device, according to the motion detection vector and the frame rate of the generated captured image. In addition, the correction control unit 30 suppresses the motion detection vector in such a manner that the image blur is not amplified in the shake correction based on the detection result, and generates the corrected motion vector to be used for the motion correction.

The correction unit 50 generates, by performing the shake correction of the captured image in such a manner that the motion indicated in the corrected motion vector supplied from the correction control unit 30 is corrected, the image signal of the captured image in which the image blur is corrected such that the reverse correction is not performed, and outputs the image signal to the image processing unit 61.

The image processing unit 61 performs, for example, a non-linear processing such as a gamma correction and a knee correction, a color correction processing, and a contour emphasis processing with respect to the image signal output from the correction unit 50. The image processing unit 61 outputs the processed image signal to the display unit 62 and the recording unit 63.

The display unit 62 configures a display panel or an electric view finder, and performs the display of the camera-through image based on the image signal output from the image processing unit 61. In addition, the display unit 62 performs a menu display or a operation state display for performing the operation setting of the imaging device 10. Moreover, in a case where the number of display pixels of the display unit 62 is less than that of the captured image, the display unit 62 performs the conversion of the captured image into the display image having the number of display pixels.

The recording unit 63 records the image signal output from the image processing unit 61 into the recording medium. The recording medium may be a removable one such as a memory card, an optical disc, and a magnetic tape, or may be fixed type hard disc drive (HDD) or a semiconductor memory module. In addition, by providing an encoder and a decoder in the recording unit 63, and performing a decompression decoding and compression encoding on the image signal, and then the encoded signal may be recorded in the recording medium. Moreover, in the recording unit 63, the image signal or the encoded signal recorded in the recording medium is read out and then the recorded image may be displayed on the display unit 62.

The user interface (user I/F) unit 64 is configured to include a zooming lever and a shooting button. The user interface (user I/F) unit 64 generates an operation signal according to the user operation, and outputs the signal to the control unit 65.

The control unit 65 includes, for example, a central processing unit (CPU), a read only memory (ROM), a random access memory (RAM). The CPU reads out and executes a control program stored in the ROM according to the necessity.

In the ROM, the program executed in the CPU, various data necessary for various processes are stored in advance. The RAM is a memory used as a so-called work area where an interim result of the processing is temporarily stored. In addition, in the ROM or the RAM, various control information or correction data are stored. The control unit 65 performs the controlling of each unit according to the operation signal from the user interface (user I/F) unit 64, and causes the operation according to the user operation to be performed in the imaging device 10.

### 3. First Embodiment

### 3-1. Configuration in First Embodiment

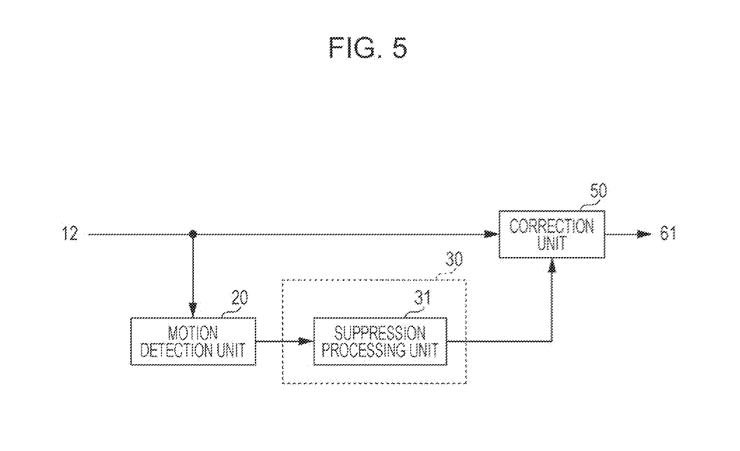

FIG. 5 illustrates a configuration of a shake correction control unit in the first embodiment. The shake correction control unit 30 is configured using the suppression processing unit 31. The suppression processing unit 31 detects the amplification of the image blur in the shake correction according to the motion detection vector and the frame rate of the captured image. The suppression processing unit 31, for example, extracts any of the two components: a component which does not amplify the image blur in a case where the shake correction is performed based on the motion detection vector and a component which amplifies the image blur. The suppression processing unit 31, in the motion detection vector based on the extraction result, calculates the stability rate that indicates the proportion of the component which does not amplify the image blur in the shake correction, and converts the stability rate into the correction rate in suppression of the motion detection vector. The suppression processing unit 31 suppresses the motion detection vector based on the correction rate, and generates a corrected motion vector which is corrected motion information. The suppression processing unit 31 outputs the corrected motion vector generated by the suppression processing unit 31 to the correction unit 50.

### 3-2. Operation in First Embodiment

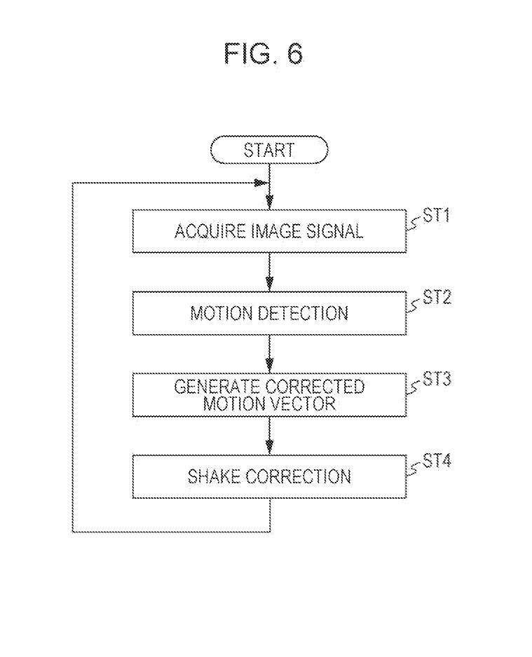

FIG. 6 is a flowchart illustrating an example of the shake correction operation in the first embodiment. In STEP ST1, the motion detection unit 20 acquires an image signal.

The motion detection unit 20 acquires the image signal generated in the imaging unit 12, and proceeds to STEP ST2.

In STEP ST2, the motion detection unit 20 performs the motion detection. The motion detection unit 20 performs the motion detection using the acquired image signal, and generates the motion detection vector that indicates the shake of the imaging device. The motion detection unit 20 outputs the generated motion detection vector to the correction control unit 30, and proceeds to STEP ST3.

In STEP ST3, correction control unit 30 generates the corrected motion vector. The suppression processing unit 31 of the correction control unit 30 detects the amplification of the image blur in the shake correction according to the frame rate of the captured image and the corrected motion detection vector generated in STEP ST2. In addition, the suppression processing unit 31 suppresses the motion detection vector in such a manner that the image blur is not amplified in the shake correction according to the detection result and generates the corrected motion vector, and proceeds to STEP ST4.

In STEP ST4, the correction unit 50 performs the shake correction. The correction unit 50 performs the shake correction based on the corrected motion vector, and generates the image signal of the captured image in which the influence of the shake of the imaging device is removed. Moreover, in the shake correction, for example, by reading out each pixel signal from a read out region which has a size larger than that of the area of the desired size from the imaging unit 12, and cutting out the image of the area of the desired size from the image of the read out region according to the corrected motion vector, and then the image signal of the captured image is generated in which the influence of the shake of the imaging device is removed. In addition, the image signal in which the shake correction is performed may be generated by changing the read out position of the image from the imaging unit 12 according to the corrected motion vector.

### 3-3. First Configuration and Operation of Suppression Processing Unit

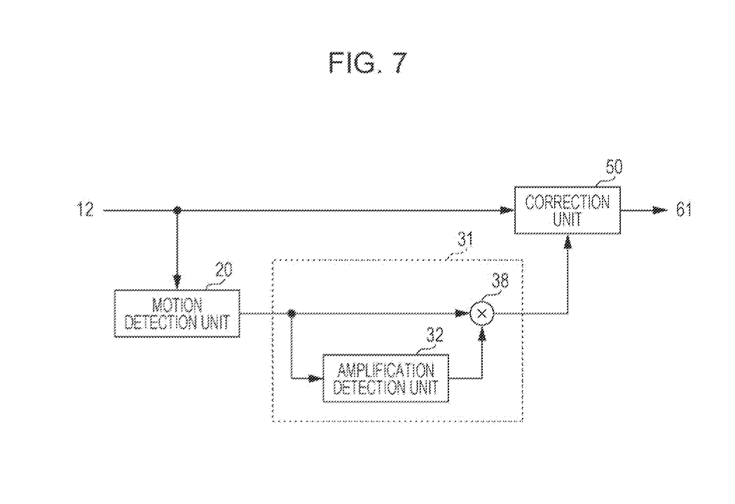

FIG. 7 is a diagram illustrating a first configuration of a suppression processing unit. The suppression processing unit 31 of the correction control unit 30 includes an amplification detection unit 32 and a multiplier 38 which is an information suppression unit.

The amplification detection unit 32 detects the image blur in the shake correction according to the frame rate of the image and the motion detection vector. For example, the amplification detection unit 32 extracts the component which does not amplify the image blur in the case where the shake correction is performed based on the motion detection vector, and calculates the proportion of the extracted component to the motion detection vector as a stability rate. Furthermore, the amplification detection unit 32 converts the stability rate into the correction rate of the motion detection vector, and outputs the correction rate to the multiplier 38. The amplification detection unit 32 converts the stability rate into the correction rate of the motion detection vector, for example, using a conversion table or by performing a calculation. The multiplier 38 performs the suppression of the motion detection vector by multiplying the motion detection vector by the correction rate, and generates the corrected motion vector, and then, outputs the corrected motion vector to the correction unit 50.

Conversion characteristics in converting the stability rate into the correction rate may be determined in advance or may be determined to be switchable. For example, the amplification detection unit 32 uses any of the following conversions as determined characteristics in advance: a conversion that emphasizes a reverse correction measure which is the suppression of the amplification of the image blur in the shake correction (reverse correction measure emphasize type), a conversion that emphasizes the accuracy of the correction (correction accuracy emphasize type), and a conversion that emphasizes both the correction accuracy and the reverse correction measure (balance type). In addition, amplification detection unit 32 may be configured so as to select any type of the characteristics.

Table 1 illustrates features of the conversion characteristics. In the reverse correction measure emphasize type, the shake correction based on the motion detection vector in the state of low stability rate is set to be more difficult to be performed. Specifically, in the interval where the stability rate is low, the correction rate interval where the correction rate is “0” (a state where the shake correction is not performed) is set to be longer than that in the correction accuracy emphasize type or in the balance type. In the correction accuracy emphasize type, the shake correction based on the motion detection vector in the state of high stability rate is set to be easier to be performed. Specifically, in the interval where the stability rate is high, the correction rate interval where the correction rate is “1” (a state where the motion detection vector is not suppressed) is set to be longer than that in the reverse correction measure emphasize type or in the balance type. In the balance type, in comparison to the reverse correction measure emphasize type, the shake correction based on the motion detection vector in the state of high stability rate is set to be easy to be performed. In addition, in the balance type, in comparison to the correction accuracy emphasize type, the shake correction based on the motion detection vector in the state of low stability rate is set to be difficult to be performed. Specifically, the stability rate interval where the correction rate is “1” is set to be approximately 0.25 (25%) which is narrower than that in the correction accuracy emphasize type, and the stability rate interval where the correction rate is “0” is set to be approximately 0.25 (25%) which is narrower than that in the reverse correction measure emphasize type.

TABLE 1

Correction rate

| | Interval “0” | Interval “1” |
|---|---|---|
| Correction | — | Set to be long |
| performance | | |
| emphasize type | | |
| Reverse | Set to be long | — |
| correction | | |
| measure emphasize | | |
| type | | |
| Balance type | Approximately 25% | Approximately 25% |

In addition, regarding a transient interval where the correction rate is larger than “0” and smaller than “1”, as indicated in Table 2, in case of a first feature in which the correction rate rapidly changes according to the stability rate, the transient interval is set to short. In addition, in case of a third feature in which the correction rate slowly changes according to the stability rate, the transient interval is set to be longer than that in the case of the first characteristics. In addition, in case of a second feature in which the correction rate changes more slowly than in the first feature and changes more rapidly than in the third feature, the transient interval is set to be longer than that in the first feature, and shorter than that in the third feature, for example, an interval of approximately “0.5” (50%).

TABLE 2

| | Correction rate |
|---|---|
| | Transient interval |
| First characteristics | Set to be short |
| Second | Approximately 50% |
| characteristics | |
| Third characteristics | Set to be long |

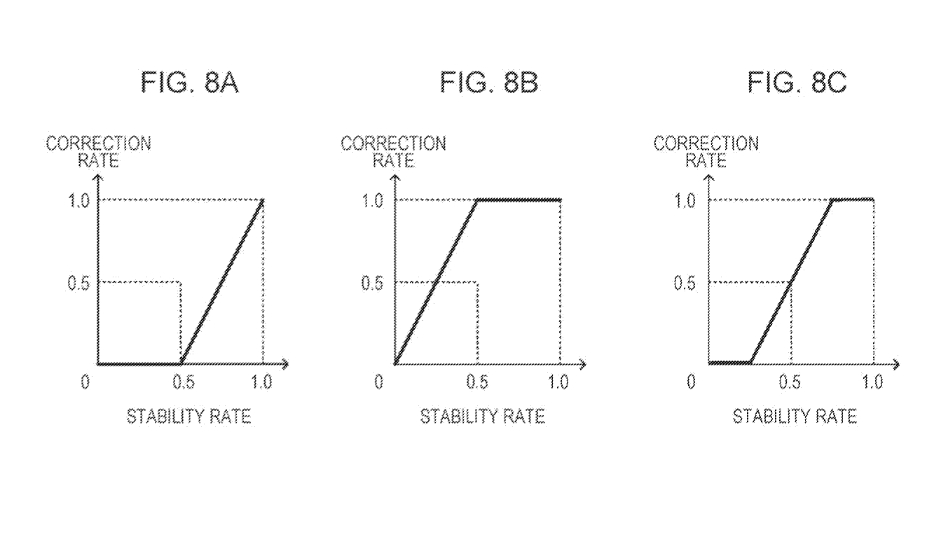

FIGS. 8A to 8C illustrate the conversion characteristics in case of converting the stability rate to the correction rate. FIG. 8A illustrates the conversion characteristics in a case where the reverse correction measure is emphasized. For example, in a case where the stability rate is lower than 0.5, the correction rate is set to be “0”. In addition, in a case where the stability rate is higher than 0.5, the correction rate is increased along with the increase of the stability rate, eventually when the stability rate is “1”, the correction rate is set to be “1”.

FIG. 8B illustrates the conversion characteristics in a case where the correction accuracy is emphasized. For example, in a case where the stability rate is equal to or higher than 0.5, the correction rate is set to be “1”. In addition, in a case where the stability rate becomes lower than “0.5”, the correction rate is decreased along with the decrease of the stability rate, eventually when the stability rate is “0”, the correction rate is set to be “0”.

FIG. 8C illustrates the conversion characteristics in a case where both of reverse correction measure and the correction accuracy are emphasized. For example, in a case where the stability rate is equal to or lower than 0.25, the correction rate is set to be “0”. In a case where the stability rate is equal to or higher than 0.75, the correction rate is set to be “1”. Furthermore, the stability rate is higher than 0.25 and lower than 0.75, the correction rate is increased along with the increase of the stability rate, the value is set to be in the range of “0” to “1”.

Moreover, in FIGS. 8A to 8C, the case is illustrated where the change of the correction rate with respect to the stability rate in the correction rate range of higher than “0” and lower than “1” is constant. However, change of the correction rate with respect to the stability rate may not be constant. For example, in the position where the correction rate is near to “0” and “1”, by reducing the amount of change in the correction rate, the correction rate may be changed smoothly.

### 3-3-1 Configuration and Operation of Amplification Detection Unit

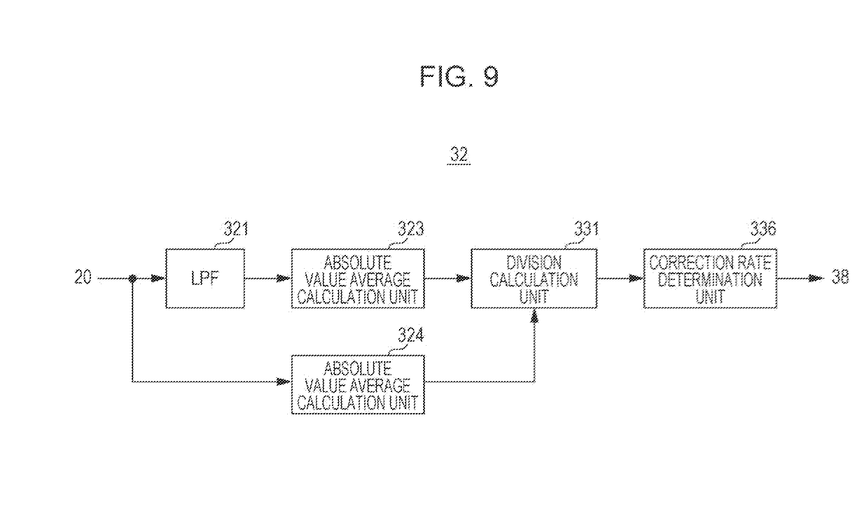

FIG. 9 illustrates a configuration example of the amplification detection unit. The amplification detection unit 32 includes a low pass filter (LPF) 321, an absolute value average calculation units 323 and 324, a division calculation unit 331, and a correction rate determination unit 336.

The low pass filter (LPF) 321 performs a filtering process on the motion detection vector, and extracts the component which does not amplify the image blur in a case where the shake correction is performed based on the motion detection vector. The LPF 321 outputs the extracted low-frequency component signal to the absolute value average calculation unit 323. Moreover, in the filtering process, when processing the pixel of the end side, the pixel of the past is used in return.

The absolute value average calculation unit 323 calculates an average value of the absolute values using the low-frequency component signal corresponding to a predetermined number of frames up to the plurality of previous frames, for example, the low-frequency component signal corresponding to 10 frames to the past direction from the present. The absolute value average calculation unit 323 outputs the calculated average value to the division calculation unit 331.

The absolute value average calculation unit 324 calculates an average value of the absolute values using the motion detection vector corresponding to a predetermined number of frames up to the plurality of previous frames, for example, the motion detection vector corresponding to 10 frames to the past direction from the present. The absolute value average calculation unit 324 outputs the calculated average value to the division calculation unit 331.

The absolute value average calculation units 323 and 324 can obtain stable average values by using the low-frequency component signal and the motion detection vector corresponding to the predetermined number of frames.

By dividing the average value calculated by the absolute value average calculation unit 323 by the average value calculated by the absolute value average calculation unit 324, the division calculation unit 331 calculates the stability rate which is a proportion of the component which does not amplify the image blur in the motion detection vector. The division calculation unit 331 outputs the calculated stability rate to the correction rate determination unit 336.

In this way, by the low pass filter (LPF) 321, the absolute value average calculation units 323 and 324, and the division calculation unit 331 performing the operation in Equation (4), the amplification detection unit 32 calculates the stability rate and outputs the calculated stability rate to the correction rate determination unit 336.

$$\begin{matrix}Stability rate = \frac{\sum \vert LPF ( {MV}_{h} ) \vert / N}{\sum \vert {MV}_{h} \vert / N} \\ = \frac{LPF pass component}{I LPF non \text{-} pass component}\end{matrix} \qquad ( 4 )$$

The correction rate determination unit 336 determines the correction rate based on the stability rate calculated by the division calculation unit 331. By using the conversion table or by performing the calculation operation as described above, the correction rate determination unit 336 performs the process of converting the stability rate to the correction rate, and then, determines the correction rate based on the stability rate.

### 3-3-2. Modification Example of Amplification Detection Unit

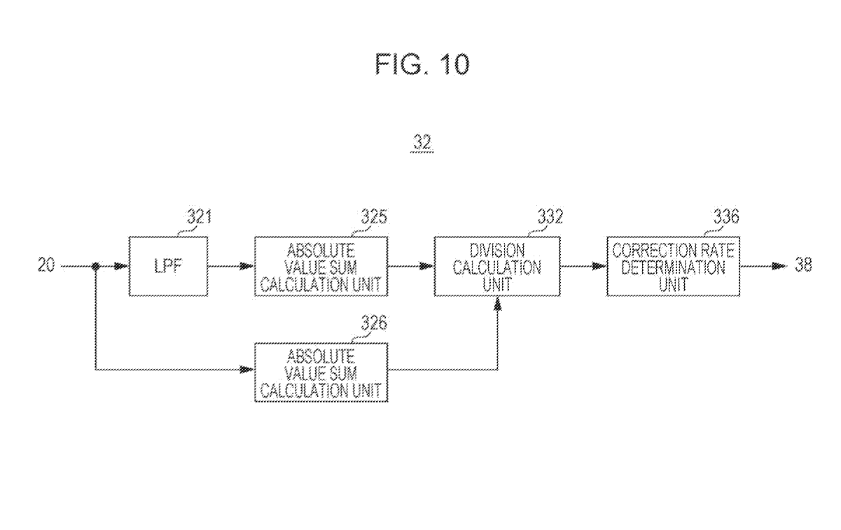

FIGS. 10 to 12 illustrate a modification example of the amplification detection unit. The amplification detection unit in FIG. 10 illustrates the case where the stability rate is calculated using the sum of the absolute values. The amplification detection unit 32 includes the low pass filter (LPF) 321, absolute value sum calculation units 325 and 326, a division calculation unit 332, and the correction rate determination unit 336.

The LPF 321 performs the filtering process on the motion detection vector, and extracts the component which does not amplify the image blur in a case where the shake correction base on the motion detection vector is performed. The LPF 321 outputs the extracted low-frequency component signal to the absolute value sum calculation unit 325.

The absolute value sum calculation unit 325 calculates the sum of the absolute values using the low-frequency component signal corresponding to a predetermined number of frames till the plurality of previous frames, for example, the low-frequency component signal corresponding to 10 frames to the past direction from now. The absolute value sum calculation unit 325 outputs the calculated sum of the absolute values to the division calculation unit 332.

The absolute value sum calculation unit 326 calculates the sum of the absolute values using the motion detection vector corresponding to a predetermined number of frames till the plurality of previous frames, for example, the motion detection vector corresponding to 10 frames to the past direction from now. The absolute value sum calculation unit 326 outputs the calculated sum of the absolute values to the division calculation unit 332.

By dividing the sum of the absolute values calculated by the absolute value sum calculation unit 325 by the sum of the absolute values calculated by the absolute value sum calculation unit 326, the division calculation unit 332 calculates the stability rate which is a proportion of the component which does not amplify the image blur in the motion detection vector. The division calculation unit 332 outputs the calculated stability rate to the correction rate determination unit 336.

The correction rate determination unit 336 determines the correction rate based on the stability rate calculated by the division calculation unit 332. By using the conversion table or by performing the calculation operation as described above, the correction rate determination unit 336 performs the process of converting the stability rate to the correction rate, and then, determines the correction rate based on the stability rate.

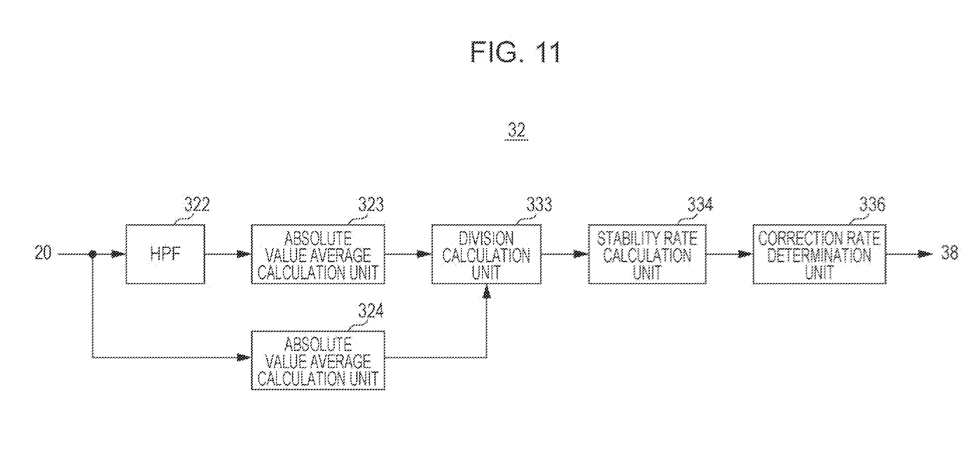

The amplification detection unit in FIG. 11 illustrates the case where the component is extracted, which amplifies the image blur in a case where the shake correction is performed. The amplification detection unit 32 includes a high pass filter (HPF) 322, the absolute value average calculation units 323 and 324, a division calculation unit 333, the stability rate calculation unit 334, and the correction rate determination unit 336.

The HPF 322 performs the filtering process of the motion detection vector, and extracts the component which amplifies the image blur in a case where the shake correction is performed based on the motion detection vector. The HPF 322 outputs the extracted high-frequency component signal to the absolute value average calculation unit 323.

The absolute value average calculation unit 323 calculates an average value of the absolute values using the high-frequency component signal corresponding to a predetermined number of frames till the plurality of previous frames, for example, the high-frequency component signal corresponding to 10 frames to the past direction from now. The absolute value average calculation unit 323 outputs the calculated average value to the division calculation unit 333.

The absolute value average calculation unit 324 calculates an average value of the absolute values using the motion detection vector corresponding to a predetermined number of frames till the plurality of previous frames, for example, the motion detection vector corresponding to 10 frames to the past direction from now. The absolute value average calculation unit 324 outputs the calculated average value to the division calculation unit 333.

By dividing the average value calculated by the absolute value average calculation unit 323 by the average value calculated by the absolute value average calculation unit 324, the division calculation unit 333 calculates the stability rate which is a proportion of the component which amplifies the image blur in the motion detection vector. The division calculation unit 333 outputs the calculated proportion to the stability rate calculation unit 334.

The stability rate calculation unit 334 performs the calculation of stability rate using the proportion calculated by the division calculation unit 333. The proportion calculated by the division calculation unit 333 is the proportion of the component which amplifies the image blur in the motion detection vector. Therefore, by performing the operation of “1−(proportion calculated by division calculation unit 333)”, the stability rate calculation unit 334 calculates the stability rate. The stability rate calculation unit 334 outputs the calculated stability rate to the correction rate determination unit 336.

The correction rate determination unit 336 determines the correction rate based on the stability rate calculated by the stability rate calculation unit 334. By using the conversion table or by performing the calculation operation as described above, the correction rate determination unit 336 performs the process of converting the stability rate to the correction rate, and then, determines the correction rate based on the stability rate.

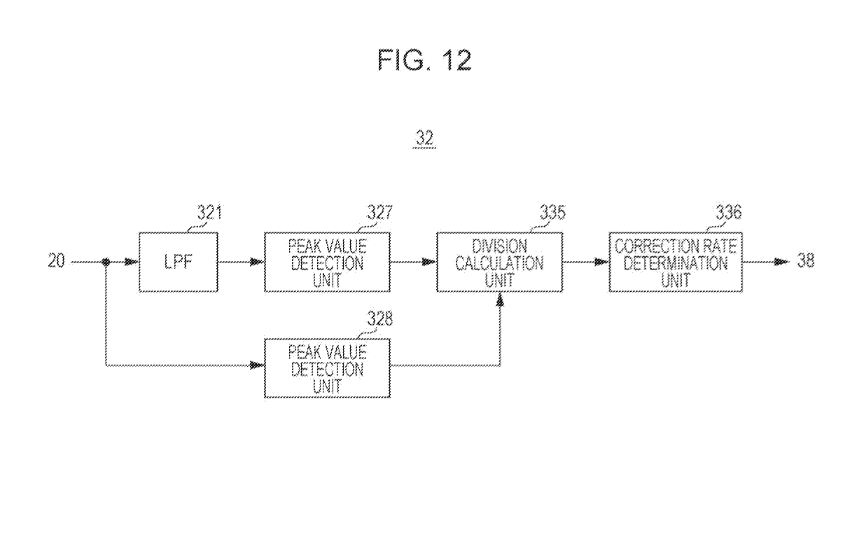

The amplification detection unit illustrated in FIG. 12 illustrates a case where the stability rate is calculated using a peak value. The amplification detection unit 32 includes the low pass filter (LPF) 321, peak value detection units 327 and 328, a division calculation unit 335, and the correction rate determination unit 336.

The LPF 321 performs the filtering process of the motion detection vector, and extracts the component which does not amplify the image blur in a case where the shake correction is performed based on the motion detection vector. The LPF 321 outputs the extracted low-frequency component signal to the peak value detection unit 327.

The peak value detection unit 327 detects the peak value from the low-frequency component signal corresponding to a predetermined number of frames till the plurality of previous frames, for example, the low-frequency component signal corresponding to 10 frames to the past direction from now. The peak value detection unit 327 outputs the detected peak value to the division calculation unit 335.

The peak value detection unit 328 detects the peak value using the motion detection vector corresponding to a predetermined number of frames till the plurality of previous frames, for example, the motion detection vector corresponding to 10 frames to the past direction from now. The peak value detection unit 328 outputs the detected peak value to the division calculation unit 335.

By dividing the peak value detected by the peak value detection unit 327 by the peak value detected by the peak value detection unit 328, the division calculation unit 335 calculates the proportion of the peak value of the component which does not amplify the image blur with respect to the peak value of the motion detection vector as the stability rate. The division calculation unit 335 outputs the calculated stability rate to the correction rate determination unit 336.

The correction rate determination unit 336 determines the correction rate based on the stability rate calculated by the division calculation unit 335. By using the conversion table or by performing the calculation operation as described above, the correction rate determination unit 336 performs the process of converting the stability rate to the correction rate, and then, determines the correction rate based on the stability rate.

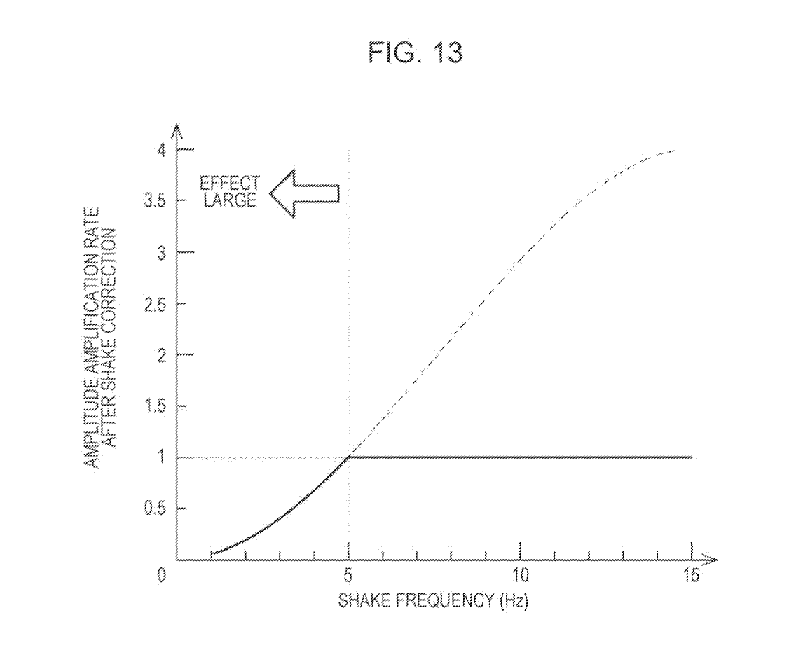

In this way, according to the first configuration of the suppression processing unit, for example, in a case where the frame rate of the captured image is 30 frames/second, and the time difference between the motion detection and the acquisition of the captured image is a period of one frame, when the shake frequency exceeds 5 Hz, in the suppression processing unit 31, the amplitude of the motion detection vector is suppressed and the corrected motion vector is generated. Therefore, the amplitude amplification rate after the shake correction described in Equation (2) above can be suppressed to “1”, and even when the shake frequency becomes as high as to exceed 5 Hz as illustrated in FIG. 13, the amplitude amplification rate after the shake correction is limited to “1”, and it is possible to suppress the reverse correction.

### 3-4. Second Configuration of Suppression Processing Unit

Incidentally, in the first configuration of the suppression processing unit described above, the case is described in which the amplitude of the motion detection vector is suppressed and the corrected motion vector is generated in such a manner that image blur does not become large due to the reverse correction at the time of performing the shake correction. However, the suppression processing unit may perform the filtering process with respect to the motion detection vector and generate the corrected motion vector that controls the shake correction in such a manner that the reverse correction is not performed. Next, the case where the filtering process with respect to the motion detection vector is performed and the corrected motion vector is generated will be described as the second configuration of the suppression processing unit.

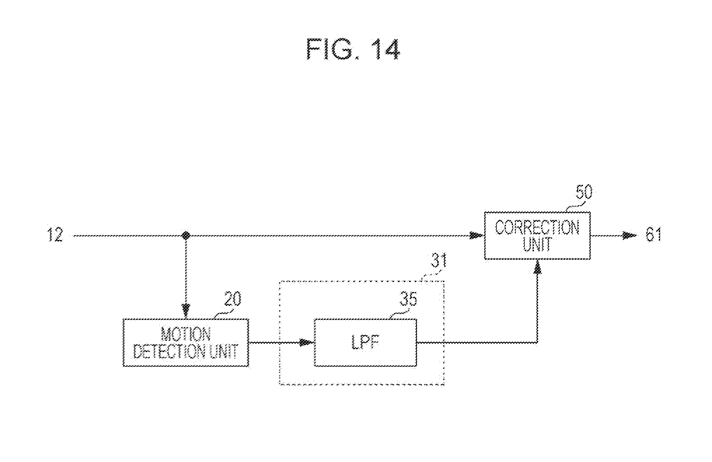

FIG. 14 illustrates the second configuration of the suppression processing unit. The suppression processing unit 31 includes a LPF 35. In the second configuration, the LPF 35 corresponds to the amplification detection unit 32 and the multiplier 38 in the first configuration. The LPF 35 performs the filtering process of the motion detection vector, and removes the component which amplifies the image blur in a case where the shake correction is performed based on the motion detection vector, from the motion detection vector. The LPF 35 outputs the filtered motion detection vector to the correction unit 50 as the corrected motion vector.

According to the second configuration, since the suppression of the motion detection vector is performed using the low pass filter, it is possible to perform the suppression processing of the motion detection vector with low delay, even though there is a concern that the suppression effect deteriorates compared to that in the first configuration.

### 3-5. Third Configuration of Suppression Processing Unit

Furthermore, the suppression processing unit may be configured in a combination of the first configuration and the second configuration. Next, the case where the corrected motion vector is generated in the combination of the first configuration and the second configuration will be described as the third configuration of the suppression processing unit 31.

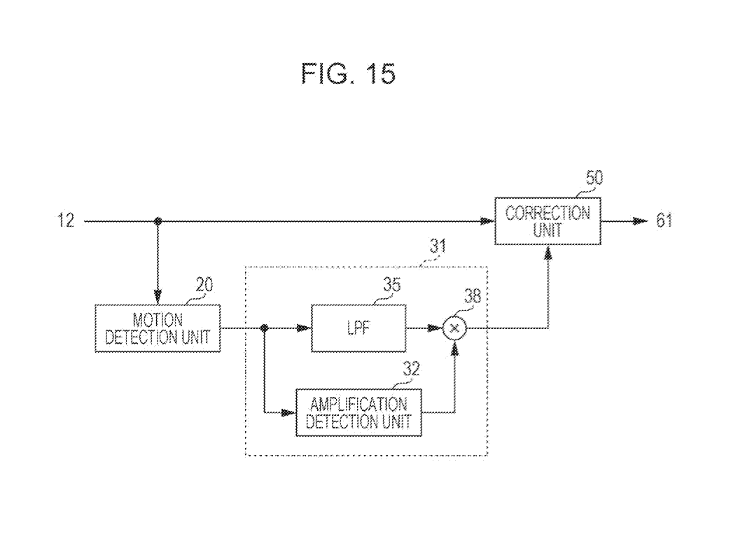

FIG. 15 illustrates the third configuration of the suppression processing unit. The suppression processing unit 31 includes the amplification detection unit 32, the low pass filter (LPF) 35, and the multiplier 38.

The amplification detection unit 32 calculates the proportion of the component which does not amplify the image blur in the case where the shake correction is performed based on the motion detection vector as the stability rate. Furthermore, the amplification detection unit 32 determines the correction rate of the shake correction based on the stability rate, and outputs the determined correction rate to the multiplier 38. The amplification detection unit 32, for example, using the conversion table or performing the operation, converts the stability rate to the correction rate.

The LPF 35 performs the filtering process of the motion detection vector, and removes the component which amplifies the image blur in the case where the shake correction is performed based on the motion detection vector. The LPF 35 outputs the filtered motion detection vector to the multiplier 38.

By multiplying the filtered motion detection vector by the correction rate, the multiplier 38 generates the corrected motion vector, and outputs the corrected motion vector to the correction unit 50.

According to the third configuration, the cost increases compared to the first and second configurations. However, the suppression processing of the motion detection vector can be performed with lower delay than that in the first configuration, and higher suppression effect can be obtained than that in the second configuration.

### 4. Second Embodiment

Incidentally, the correction control unit in the first embodiment has an object of preventing the reverse correction in which the image blur is amplified by the shake correction. However, the correction control unit may be configured such that the shake correction can be performed with a high accuracy as well as the reverse correction is prevented. Next, in the second embodiment, the configuration and the operation of the correction control unit in which the shake correction can be performed with a high accuracy as well as the reverse correction is prevented, will be described.

### 4-1. Configuration in Second Embodiment

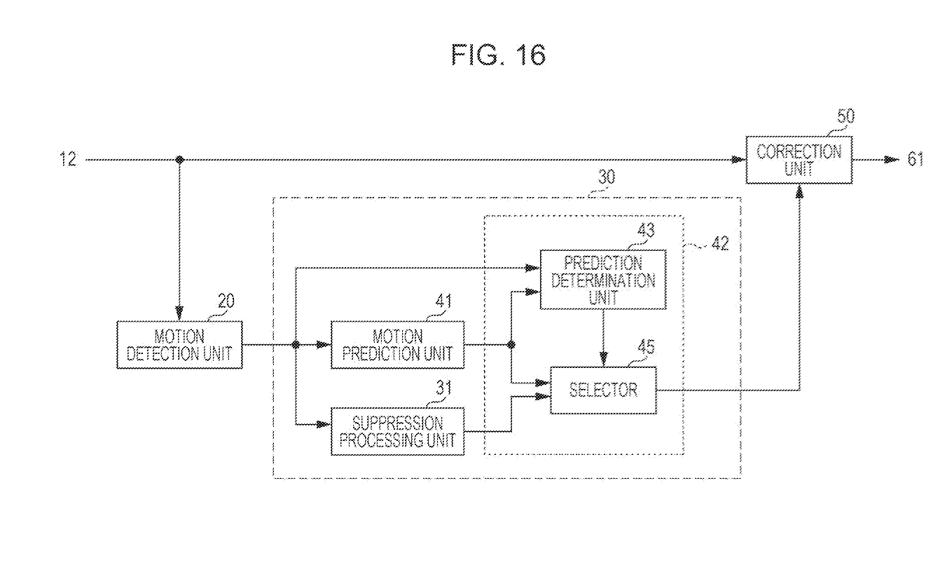

FIG. 16 illustrates the configuration of the shake correction control unit in the second embodiment. The shake correction control unit 30 is configured using the suppression processing unit 31, a motion prediction unit 41, and a selection processing unit 42.

The suppression processing unit 31, as similar to the first embodiment, detects the amplification of the image blur in the shake correction according to the motion detection vector and the frame rate of the captured image, and performs the suppression of the motion detection vector based on the detection result, and outputs suppressed motion detection vector to the selection processing unit 42.

The motion prediction unit 41 predicts the motion at the time of the acquisition of the captured image based on the motion detection vector. The motion prediction unit 41 generates motion prediction information which indicates the motion prediction result, that is, the motion prediction vector, and outputs the motion prediction vector to the selection processing unit 42.

The selection processing unit 42 includes a prediction determination unit 43 and a selector 45. The prediction determination unit 43 calculates a prediction error based on the motion prediction vector and the motion detection vector, and determines whether or not the prediction error is smaller than the threshold value determined in advance. The prediction determination unit 43 determines the prediction as prediction success when the prediction error is smaller than the threshold value, and determines the prediction as prediction failure when the prediction error is equal to or larger than the threshold value, and outputs the determination result to the selector 45.

The selector 45 selects any one of the suppressed motion vectors supplied from the suppression processing unit 31 or the motion prediction vector supplied from the motion prediction unit 41 as the corrected motion vector, based on the determination result by the prediction determination unit 43. The selector 45, in a case where the determination result is indicated as prediction success, selects the motion prediction vector supplied from the motion prediction unit 41, and outputs the motion prediction vector to the correction unit 50 as the corrected motion vector. In addition, the selector 45, in a case where the determination result is indicated as prediction failure, selects the suppressed motion vector supplied from the suppression processing unit 31, and outputs the suppressed motion vector to the correction unit 50 as the corrected motion vector.

The correction unit 50 performs the shake correction using the corrected motion vector supplied from the selection processing unit 42, and generates the image signal of the captured image in which the image blur is corrected, and outputs the image signal to the image processing unit 61.

### 4-2. Operation in Second Embodiment

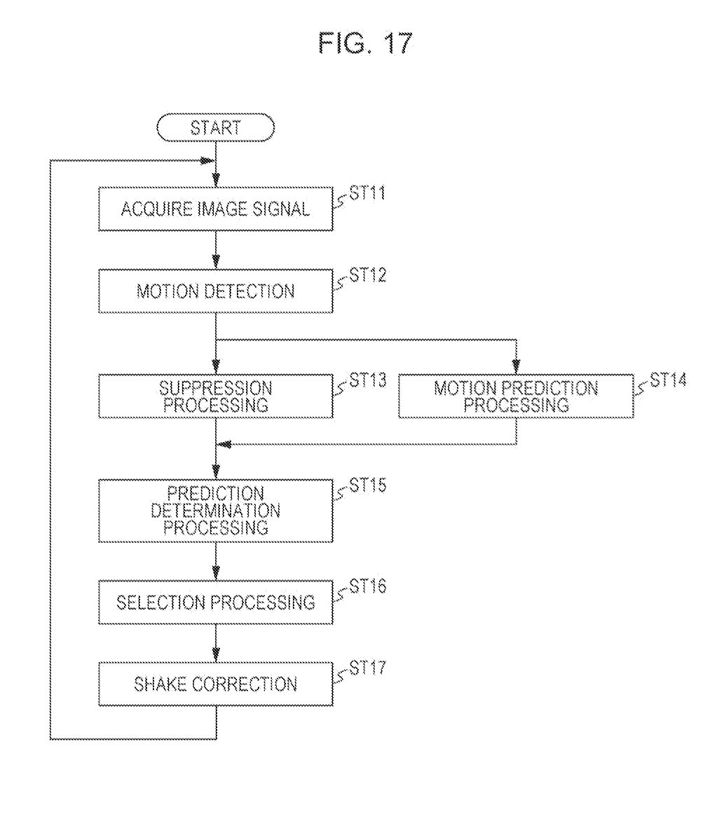

FIG. 17 is a flowchart illustrating a shake correction operation in the second embodiment. The motion detection unit 20 acquires an image signal in STEP ST11. The motion detection unit 20 acquires the image signal generated by the imaging unit 12, and proceeds to STEP ST12.

The motion detection unit 20 performs the motion detection in STEP ST12. The motion detection unit 20 performs the motion detection using the acquired image signal, and generates the motion detection vector that indicates the shake of the imaging device. The motion detection unit 20 outputs the generated motion detection vector to the correction control unit 30, and proceeds to STEPs ST13 and ST14.

The correction control unit 30 performs the suppression processing in STEP ST13. The suppression processing unit 31 of the correction control unit 30 detects the amplification of the image blur in the shake correction according to the frame rate of the captured image and the motion detection vector generated in STEP ST12. In addition, the suppression processing unit 31 suppresses the motion detection vector so as not amplify the image blur in the shake correction according to the detection result, and proceeds to STEP S15.

The correction control unit 30 performs the motion prediction in STEP ST14. The correction control unit 30 predicts the motion at the time of acquisition of the captured image using the motion detection vector generated in STEP ST12, and generates the motion prediction vector that indicates the prediction result, and proceeds to STEP ST15. Here, FIG. 17 illustrates the case where the processing in STEPs ST13 and ST14 are performed in parallel. However, any one of the processing in STEPs ST13 and ST14 may be performed first, and then the other processing may be performed.

The correction control unit 30 performs the prediction determination in STEP ST15. The correction control unit 30 calculates the prediction error based on the motion prediction vector and the motion detection vector, and compares the calculated prediction error and the threshold value set in advance. The correction control unit 30 determines the prediction to be successful when the prediction error is smaller than the threshold value, and determines the prediction to be failed when the prediction error is equal to or larger than the threshold value, and proceeds to STEP ST16.

The correction control unit 30 performs the selection processing in STEP ST16. The correction control unit 30, in a case where the determination result in STEP ST15 is prediction success, selects the motion prediction vector generated in STEP ST14 as the corrected motion vector. In addition, the correction control unit 30, in a case where the determination result in STEP ST15 is prediction failure, selects the suppressed motion detection vector generated in STEP ST13 as the corrected motion vector, and proceeds to STEP ST17.

The correction unit 50 performs the shake correction in STEP ST17. The correction unit 50 performs the shake correction using the corrected motion vector obtained in the selection processing in STEP ST16, and generates the image signal of the captured image in which the influence of the shake of the imaging device is removed. Moreover, in the shake correction, for example, by reading out each pixel signal from a read out region which has a size larger than that of the area of the desired size from the imaging unit 12, and by cutting out the image of the area of the desired size from the image of the read out region according to the corrected motion vector, and then the image signal of the captured image is generated, in which the influence of the shake of the imaging device is removed. In addition, the image signal in which the shake correction is performed may be generated by changing the read out position of the image from the imaging unit 12 according to the corrected motion vector.

### 4-3. Regarding Motion Prediction

As a method of prediction used in motion prediction, prediction models such as a kinetic model, a polynomial approximation model, an autoregressive model and like can be used.

In the kinetic model, the motion prediction is performed using the kinetic model according to the motion of the imaging device. As examples of the kinetic model, a uniform motion, a uniformly accelerated motion, and a vibration motion are included. In the uniform motion, Equation (5) is satisfied. In addition, in the uniformly accelerated motion, Equation (6) is satisfied. In the vibration motion, Equation (7) is satisfied. Moreover, in Equation (7), the values of parameter “Aj, Bj, and Cj” may be calculated using a steepest descent method.

$$\begin{matrix}MV ( t ) = MV ( t - 1 ) & ( 5 ) \\ MV ( t ) = MV ( t - 1 ) + \{ MV ( t - 1 ) - MV ( t - 2 ) \} & ( 6 ) \\ MV ( t ) = {\sum }_{i = 0}^{m} {C}_{i} {t}^{i} + {\sum }_{j = 0}^{n} \{ {A}_{j} sin ( {ω}_{j} t ) - {B}_{j} cos ( {ω}_{j} t ) \} & ( 7 )\end{matrix}$$

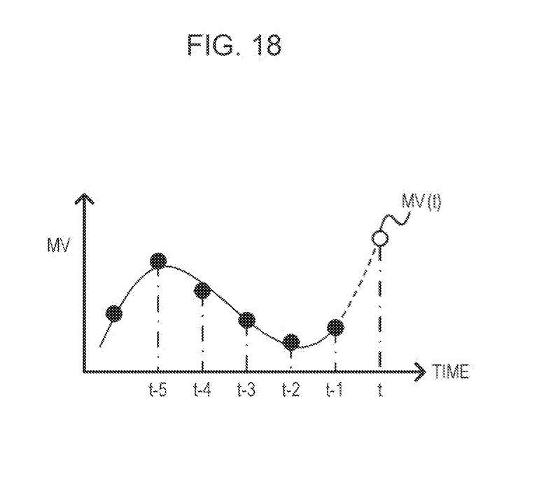

In the polynomial approximation model, for example, a function that approximates the motion is obtained by the fitting using a second to fourth approximation function, and then the motion prediction is performed by the function. For example, as illustrated in FIG. 18, by approximating the motion of a black dot through the function of the order k using data (motion of a black dot) until the point in time (t−1), and then, by using the approximation function, the motion vector MV(t) at the point in time t can be calculated as illustrated in Equation (8). Moreover, the approximation function Di may be calculated using a least-square method.

$$MV ( t ) = {\sum }_{i = 0}^{m} {D}_{i} {t}^{i} \qquad ( 8 )$$

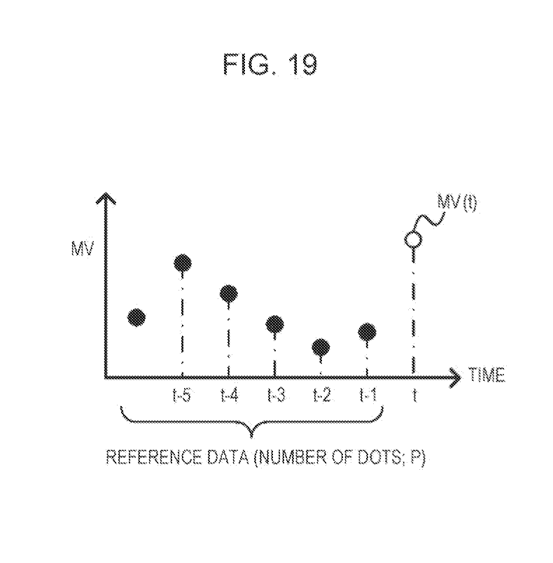

In the autoregressive model, as illustrated in FIG. 19 for example, the motion vector MV(t) at the point in time (t) is calculated using the reference data of p black dots until the point in time (t−1). Moreover, in the equation of the autoregressive model illustrated in Equation (9), an autoregressive coefficient Gi may be calculated using a yule-walker method, a burg method, or the like.

$$MV ( t ) = {\sum }_{i = 1}^{p} G ( i ) MV ( t - i ) + e ( t ) \qquad ( 9 )$$

### 4-4. First Configuration and Operation of Prediction Determination Unit

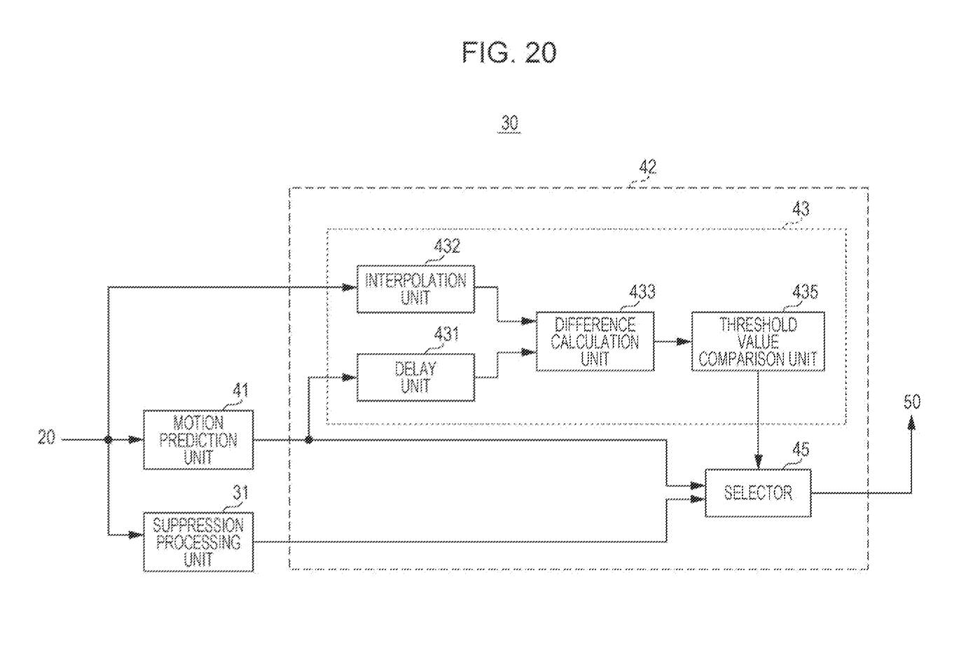

FIG. 20 illustrates a first configuration of the prediction determination unit. The motion prediction unit 41 performs the motion prediction using any of prediction models described above, and outputs the motion prediction vector to the selection processing unit 42.

The selection processing unit 42 includes the prediction determination unit 43 and selector 45, and the prediction determination unit 43 includes a delay unit 431, an interpolation unit 432, a difference calculation unit 433, and a threshold value comparison unit 435.

The delay unit 431 causes the motion prediction vector acquired by the motion prediction unit 41 to be delayed, and synchronizes with the motion detection vector generated by the motion detection unit 20. The delay unit 431 outputs the delayed motion prediction vector to the difference calculation unit 433.

The interpolation unit 432, for example, performs the generation of motion detection vectors for each frame in a case where the delayed amount in the delay unit 431 is not a period of an integer number of samples, or performs interpolation processing in a case where the delay of the motion detection vector with respect to the motion prediction vector is not a period of the integer number of samples. By performing the interpolation using the motion detection vector, the interpolation unit 432 generates the motion detection vector which is synchronized with the motion prediction vector. The interpolation unit 432 outputs the generated motion detection vector to the difference calculation unit 433.

The difference calculation unit 433 calculates the difference between the motion prediction vector supplied from the delay unit 431 and the motion detection vector supplied from the interpolation unit 432. The motion prediction vector and the motion detection vector supplied to the difference calculation unit 433 are the motion vectors having the synchronized timing. Therefore, the difference calculated in the difference calculation unit 433 indicates the prediction error. The difference calculation unit 433 outputs the calculated difference, that is, the prediction error to the threshold value comparison unit 435.

The threshold value comparison unit 435 compares the prediction error calculated by the difference calculation unit 433 with the threshold value set in advance. The threshold value comparison unit 435 determines the prediction to be successful when the prediction error is smaller than the threshold value, and determines the prediction to be failed when the prediction error is equal to or larger than the threshold value. The threshold value comparison unit 435 outputs the determination signal indicating the determination result to the selector 45.

The selector 45 selects any one of the suppressed motion detection vectors supplied from the suppression processing unit 31 or the motion prediction vector supplied from the motion prediction unit 41 as the corrected motion vector, based on the determination result by the prediction determination unit 43. The selector 45, in a case where the determination result is indicated as prediction success, selects the motion prediction vector supplied from the motion prediction unit 41, and outputs the motion prediction vector to the correction unit 50 as the corrected motion vector. In addition, the selector 45, in a case where the determination result is indicated as prediction failure, selects the suppressed motion detection vector supplied from the suppression processing unit 31, and outputs the selected motion prediction vector to the correction unit 50 as the corrected motion vector.

The correction unit 50 performs the shake correction using the corrected motion vector supplied from the selection processing unit 42, and generates the image signal of the captured image in which the image blur is corrected, and outputs the image signal to the image processing unit 61.

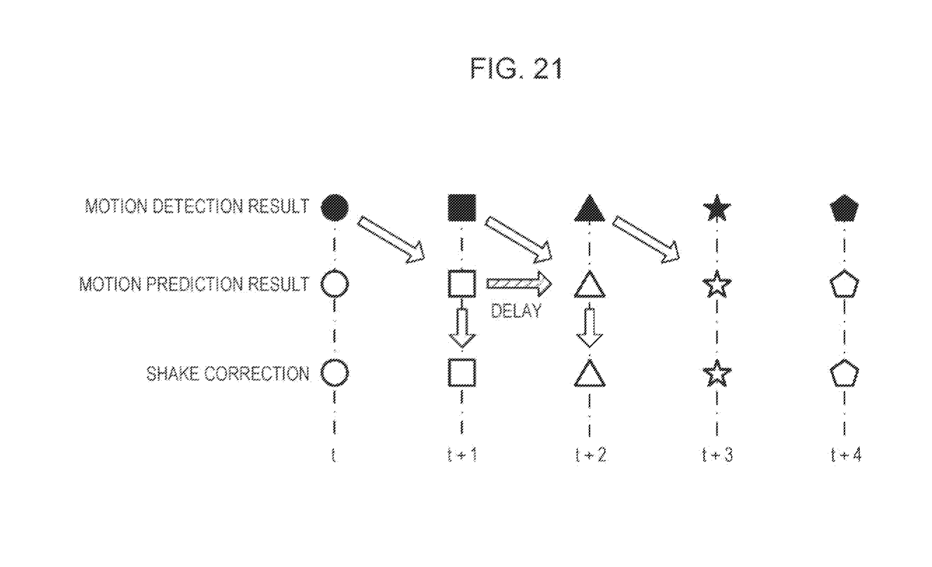

FIG. 21 illustrates the timing of the motion detection result, the motion prediction result and the shake correction. FIG. 21 illustrates the case where the shake correction is performed at the timing of one frame period delayed from the motion detection.

For example, at the point in time (t+1), the motion prediction is performed using the motion detection result up to the point in time t of the previous frame, and the motion prediction result with respect to the image at the point in time (t+1) is generated. When the motion detection is performed at the point in time (t+1), the motion detection result with respect to the image at the point in time (t+1) can be obtained at the point in time (t+2) of the next one frame. Therefore, by causing the motion prediction result of the point in time (t+1) to be delayed by one frame, the prediction error of the motion prediction result with respect to the motion detection result in the image at the point in time (t+1) can be calculated. In a case where the detection error is smaller than the threshold value, the prediction is determined to be successful, and the shake correction is performed using the motion prediction result. Moreover, as the motion prediction result used in the shake correction, the shake correction is performed using the motion prediction result calculated at the point in time (t+2), that is, the motion prediction vector generated by performing the motion prediction from the motion detection vector up to the point in time (t+1). In addition, by performing the similar process with respect to the subsequent frames, the shake correction of the captured image can be subsequently performed.

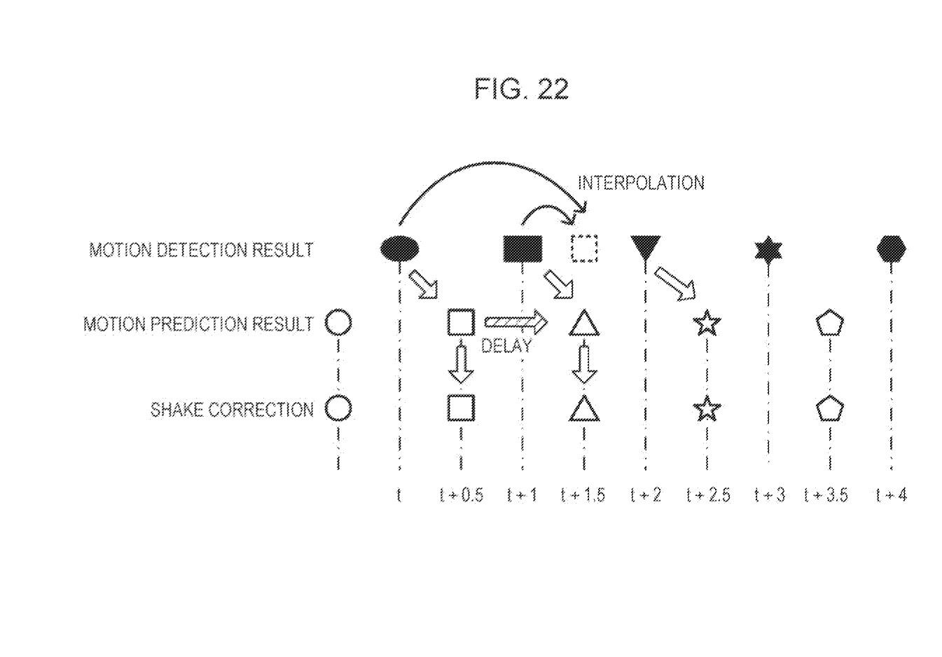

FIG. 22 illustrates the timing of the motion detection result, a motion prediction result and the shake correction. FIG. 22 illustrates the case where the shake correction is performed at the timing of 0.5 frame period delayed from the motion detection.

For example, at the point in time (t+0.5), using the motion detection result up to the point in time t of the previous one frame, the motion prediction result with respect to the image at the point in time (t+0.5) is generated. In addition, the motion detection result at the point in time (t+1) which is 0.5 frame after the point in time (t+0.5) is obtained. Therefore, by performing the interpolation using the motion prediction result at the point in time t and (t+1), the motion prediction result with respect to the image at the point in time (t+0.5) can be generated. Furthermore, by causing the motion prediction result at the point in time (t+0.5) to be delayed by one frame, the prediction error of the motion prediction result with respect to the motion detection result calculated by the interpolation for the image at point in time (t+0.5) can be calculated. In a case where the prediction error is smaller than the threshold value, the shake correction is performed using the motion prediction result which is determined to be successful. Moreover, as the motion prediction result used in the shake correction, the shake correction is performed using the motion prediction result calculated at the point in time (t+1.5), that is, the motion prediction vector generated by performing the motion prediction from the motion detection vector up to the point in time (t+1). In addition, by performing a similar processing with respect to the subsequent frames, it is possible to sequentially perform the shake correction of the captured images.

In this way, the correction control unit performs the motion prediction, and then, in case of the prediction success, by performing the correction using the corrected motion vector generated by the motion prediction, it is possible to perform the correction with high accuracy. Furthermore, in case of the prediction failure, the correction is performed by the correction unit 50 using the suppression processed motion detection vector generated by the suppression processing unit 31. Accordingly, it is possible to prevent the reverse correction from occurring in the shake correction. Therefore, it is possible to further improve the performance of the shake correction.

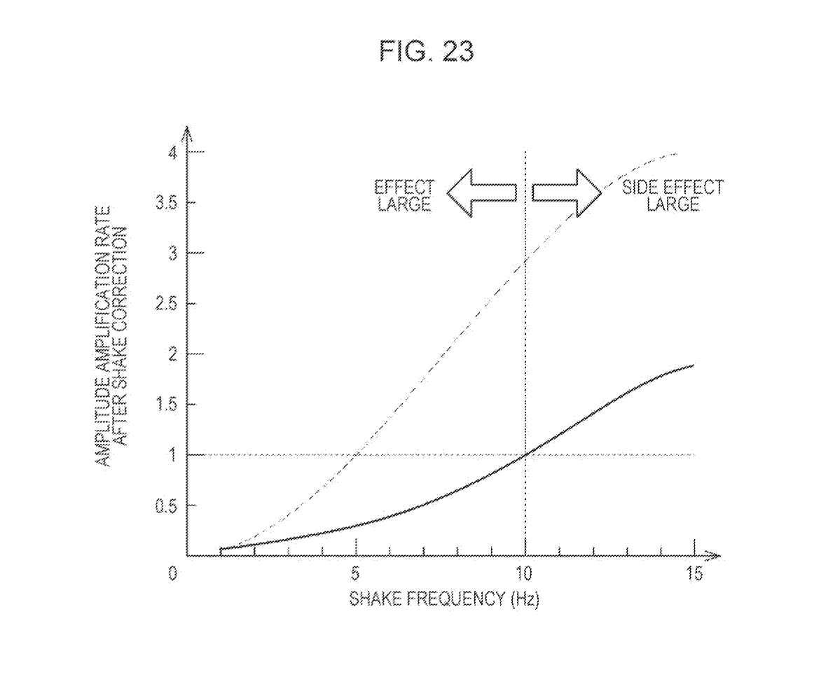

FIG. 23 illustrates the amplitude amplification rate after the shake correction when the shake correction is performed using the motion prediction result. As illustrated in FIG. 23, by using the motion prediction, the shake correction can be performed with high accuracy, and the range of the shake frequency in which the shake correction is possible can be widened.

### 4-5. Second Configuration and Operation of Prediction Determination Unit

Incidentally, the first configuration of the prediction determination unit described above, the case is described in which the motion prediction vector generated by using one prediction model is used. However, a plurality of prediction models may be used for the motion prediction. Next, in the second configuration and the operation of the prediction determination unit, the case will be described in which the motion prediction is performed using a plurality of prediction models.

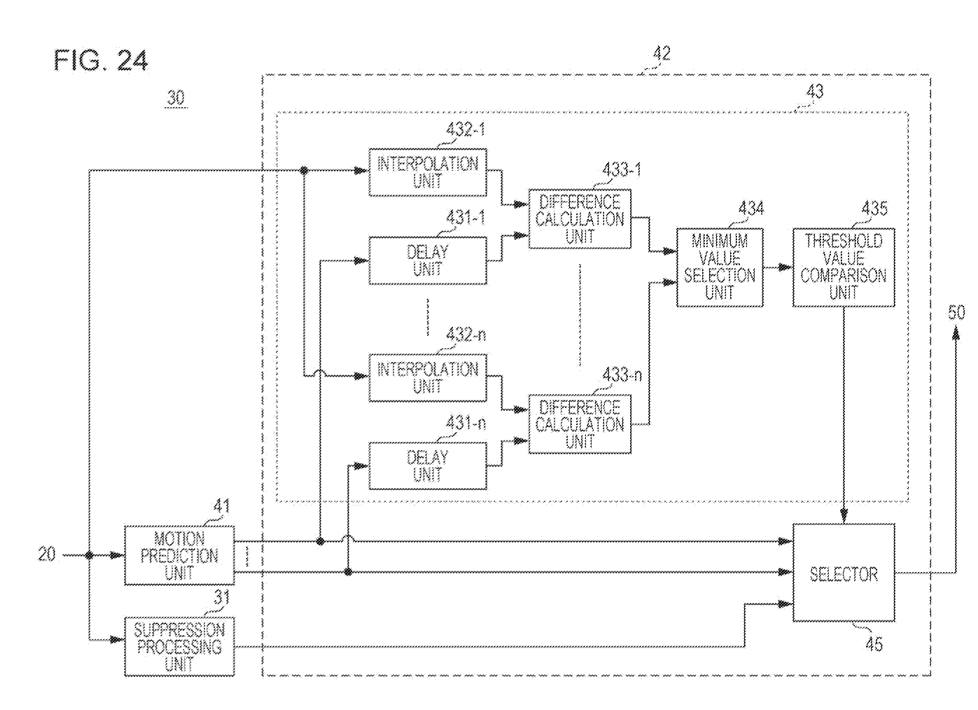

FIG. 24 illustrates a second configuration of the prediction determination unit. The motion prediction unit 41 performs the motion prediction using a plurality of, for example, n types of prediction models, and generates the motion prediction vector for each prediction model, and then outputs motion prediction vectors to the selection processing unit 42.

The suppression processing unit 31, similar to the first embodiment, detects the amplification of the image blur in the shake correction according to the frame rate of the captured image, and performs the suppression of the motion detection vector based on the detection result, and then outputs the suppressed motion vector to the selection processing unit 42.

The motion prediction unit 41 predicts the motion at the time of acquisition of the captured image based on the motion detection vector. The motion prediction unit 41 performs the motion prediction using n types of prediction models, and generates motion prediction information which indicates the prediction result for each prediction model, that is, the motion prediction vector, and then outputs the motion prediction vector to the selector 45. In addition, the motion prediction unit 41 outputs the motion prediction vector to the selection processing unit 42.

The selection processing unit 42 includes the prediction determination unit 43 and the selector 45. The prediction determination unit 43 includes the delay units 431-1 to 431-n, the interpolation units 432-1 to 432-n, the difference calculation units 433-1 to 433-n, a minimum value selection unit 434, and the threshold value comparison unit 435.

The delay unit 431-1 causes the motion prediction vector in a case where a first prediction model is used, and acquired by the motion prediction unit 41 to be delayed, and synchronizes with the motion detection vector generated by the motion detection unit 20. The delay unit 431-1 outputs the delayed motion prediction vector to the difference calculation unit 433-1. In addition, other delay units also perform the similar processing as the delay unit 431-1 does, for example, the delay unit 431-n causes the motion prediction vector in a case where a n-th prediction model is used, and acquired by the motion prediction unit 41 to be delayed, and synchronizes with the motion detection vector generated by the motion detection unit 20. The delay unit 431-n outputs the delayed motion prediction vector to the difference calculation unit 433-n.

By performing the interpolation processing using the motion detection vector in a case where the delayed amount in the delay unit 431-1 is not a period of integer number of samples as described above, the interpolation unit 432-1 generates the motion detection vector which is synchronized with the motion prediction vector. The interpolation unit 432-1 outputs the generated motion detection vector to the difference calculation unit 433-1. Other interpolation units also perform the similar processing as the interpolation unit 432-1 does, for example, by performing the interpolation processing using the motion detection vector in a case where the delayed amount in the delay unit 431-n is not a period of integer number of samples, the interpolation unit 432-n generates the motion detection vector which is synchronized with the motion prediction vector. The interpolation unit 432-n outputs the generated motion detection vector to the difference calculation unit 433-n.

The difference calculation unit 433-1 calculates the difference between the motion prediction vector supplied from the delay unit 431-1 and the motion detection vector supplied from the interpolation unit 432-1. Here, the motion prediction vector and the motion detection vector supplied to the difference calculation unit 433-1 are the motion vectors having synchronized timing. Therefore, the difference calculated in the difference calculation unit 433-1 indicates the prediction error in a case where the first prediction model is used. The difference calculation unit 433-1 outputs the calculated prediction error to the minimum value selection unit 434. Other difference calculation units also perform the similar processing as the difference calculation unit 433-1 does, for example, the difference calculation unit 433-n calculates the prediction error between the motion prediction vector supplied from the delay unit 431-n and the motion detection vector supplied from the interpolation unit 432-n, and outputs the prediction error to the minimum value selection unit 434.

The minimum value selection unit 434 compares the prediction error supplied from the difference calculation unit 433-1 through 433-n, and selects the minimum prediction error. The minimum value selection unit 434 outputs the minimum prediction error to the threshold value comparison unit 435 together with optimal prediction model information that indicates the prediction model from which the minimum prediction error is derived.

The threshold value comparison unit 435 compares the minimum prediction error selected by the minimum value selection unit 434 with the threshold value set in advance. The threshold value comparison unit 435 determines the prediction as prediction success when the prediction error is smaller than the threshold value, and determines the prediction as prediction failure when the prediction error is equal to or larger than the threshold value. The threshold value comparison unit 435 outputs the determination result to the selector 45 together with the optimal prediction model information.

The selector 45 selects any one of the suppressed motion detection vector supplied from the suppression processing unit 31 or the motion prediction vector supplied from the motion prediction unit 41 based on the determination result by the prediction determination unit 43. The selector 45, in a case where the determination result is indicated as prediction success, selects the motion prediction vector generated using the prediction model which is indicated in the optimal prediction model information, and outputs the selected motion prediction vector to the correction unit 50 as the corrected motion vector. In addition, the selector 45, in a case where the determination result is indicated as prediction failure, selects the suppressed motion detection vector supplied from the suppression processing unit 31, and outputs the selected suppressed motion detection vector to the correction unit 50 as the corrected motion vector.

The correction unit 50 performs the shake correction using the corrected motion vector supplied from the selection processing unit 42, and generates the image signal of the captured image in which the image blur is corrected, and outputs the image signal to the image processing unit 61.

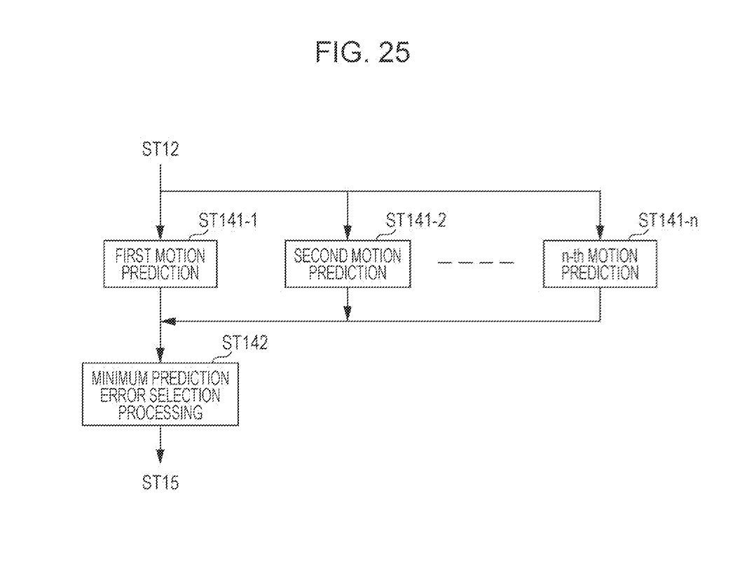

In addition, in a case where the motion prediction is performed using a plurality of prediction models, the processes in the flowchart illustrated in FIG. 25 are performed instead of the process in STEP ST14 illustrated in FIG. 17. In STEP ST141-1, the correction control unit 30 performs the first motion prediction. The correction control unit 30 predicts the motion at the time of acquisition of the captured image from the motion detection by the first prediction model, using the motion detection vector, and generates the first motion prediction vector indicating the prediction result, and then proceeds to STEP ST142.

In STEP ST141-2, the correction control unit 30 performs the second motion prediction. The correction control unit 30 performs the motion prediction as similar in the STEP ST141-1 using the second prediction model that is different from the first prediction model, and generates the second motion prediction vector which indicates the prediction result, and then proceeds to STEP ST142. In STEP ST141-n, the correction control unit 30 performs the n-th motion prediction. The correction control unit 30 performs the motion prediction as similar in the STEP ST141-1 using the n-th prediction model that is different from the first to (n−1)th prediction model, and generates the n-th motion prediction vector which indicates the prediction result, and then proceeds to STEP ST142. Here, the processing from STEP ST141-1 to STEP ST141-n may be performed in parallel, or may be subsequently performed.

In STEP ST142, correction control unit 30 performs the minimum prediction error selection processing. The correction control unit 30 calculates the prediction error of various prediction vectors using the first to n-th motion prediction vectors and the motion detection vector. In addition, the correction control unit 30 selects the minimum prediction error and the motion prediction vector of the minimum prediction error, and then proceeds to STEP ST15, and compares the minimum prediction error with the threshold value set in advance.

In this way, by performing the motion prediction using a plurality of prediction models, the shake correction is performed based on the motion prediction vector generated using the prediction model from which the minimum prediction error is derived. Therefore, compared to the case where the motion prediction is performed using one prediction model, the shake correction can be performed with higher accuracy, thus, it is possible to improve the performance of the shake correction.

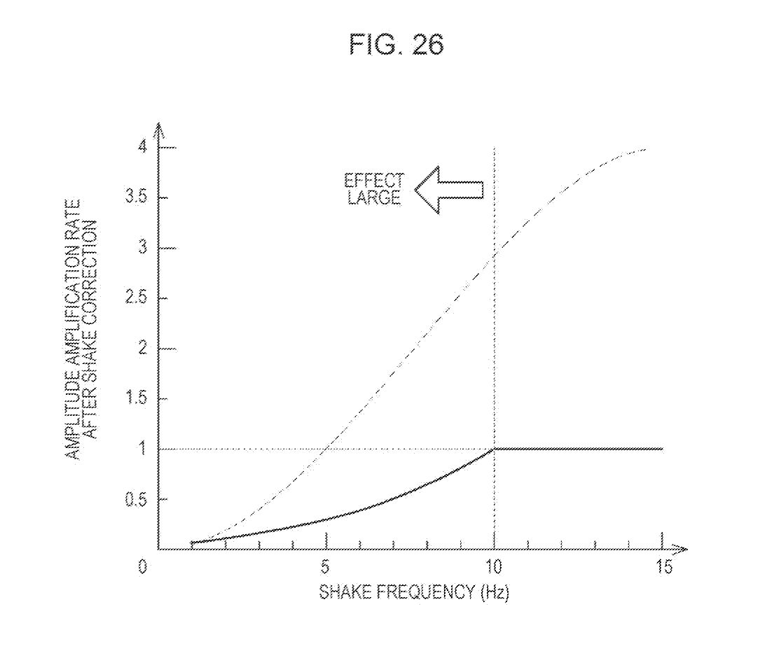

In addition, in the second embodiment, by obtaining a shake frequency in which the amplitude amplification rate after the shake correction exceeds “1” by experiments or the like in advance for each prediction model, and then using the motion prediction result and suppression processing, the shake correction may be performed. For example, as illustrated in FIG. 26, in a case where the shake frequency exceeds the frequency obtained in advance, if the motion detection vector suppressed by the suppression processing unit is selected by the selector, the reverse correction can be prevented even in case of using the prediction model.

### 5. Other Embodiments

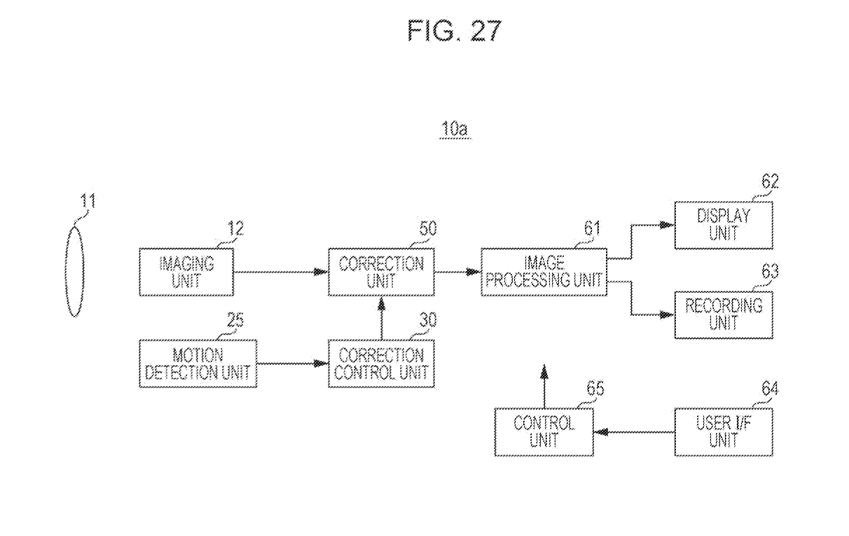

In addition, the imaging device is not limited to the case of detecting the shake of the imaging device from the image signal as illustrated in FIG. 2. For example, the technology is also applicable to the case of detecting the shake of an imaging device using a motion detection sensor. FIG. 27 illustrates an example of a configuration of an imaging device in which the motion detection sensor is used.

An imaging device 10a includes the imaging optical system 11, the imaging unit 12, a motion detection unit 25, the correction control unit 30, and the correction unit 50. Further, the imaging device 10a includes the image processing unit 61, the display unit 62, the recording unit 63, the user interface (I/F) unit 64, and the control unit 65.

The imaging optical system 11 is configured to have a focus lens or a zoom lens, and the like. In the imaging optical system 11, for example, a focus adjustment is performed by moving the focus lens in an optical axis direction. In addition, a focal length can be varied by moving the zoom lens in the optical axis direction.

The imaging unit 12 is configured to include the imaging element, a pre-processing unit, the imaging drive unit, and the like. The imaging element performs the photoelectric conversion processing to convert the optical image formed on the imaging surface by the imaging optical system 11 into the electric signal. For example, the charge coupled device (CCD) image sensor or the complementary metal oxide semiconductor (CMOS) image sensor is used as the imaging element. The pre-processing unit performs the noise removing process such as the correlated double sampling (CDS) with respect to the electric signal generated in the imaging element. In addition, the pre-processing unit performs the gain adjustment to make the electric signal level a desired signal level. Furthermore, the pre-processing unit performs the A/D conversion processing to convert an analog imaging signal which is the electric signal in which the noise is removed and the gain adjustment is performed into the digital signal, and output the digital image signal to the motion detection unit 20 and the correction unit 50. The imaging drive unit performs the generation of the operation pulse and the like necessary for driving the imaging element based on the control signal from the control unit 65 described later. For example, the imaging drive unit performs the generation of the charge readout pulse for reading out the charge, the transmission pulse for performing a transmission in the vertical or horizontal direction, and the shutter pulse for performing an electronic shutter operation and the like.

The motion detection unit 25 is configured using a gyro sensor or the like, and detects the shake of the imaging device 10a. The motion detection unit 25 calculates an amount of shake based on the sensor output from the gyro sensor or the like, and then outputs the motion detection vector which indicates the calculation result to the correction control unit 30.

The correction control unit 30 detects the amplification of the image blur in the shake correction according to the frame rate of the captured image and the motion detection vector which is motion information indicating the motion occurred at the time of generating the captured image. In addition, the correction control unit 30 suppresses the motion detection vector in such a manner that the image blur is not amplified in the shake correction based on the detection result, and generates the corrected motion vector to be used for the corrected motion information.

The correction unit 50 generates, by performing the shake correction of the captured image in such a manner that the motion indicated in the corrected motion vector supplied from the correction control unit 30 is corrected, the image signal of the captured image in which the image blur is corrected such that the reverse correction is not performed, and outputs the image signal to the image processing unit 61.

The image processing unit 61 performs, for example, a non-linear processing such as a gamma correction and a knee correction, a color correction processing, and a contour emphasis processing with respect to the digital image signal output from the correction unit 50. The image processing unit 61 outputs the processed image signal to the display unit 62 and the recording unit 63.

The display unit 62 configures the display panel or the electric view finder, and performs the display of the camera-through image based on the image signal output from the image processing unit 61. In addition, the display unit 62 performs the menu display or the operation state display for performing the operation setting of the imaging device 10. Moreover, in a case where the number of display pixels of the display unit 62 is less than that of the captured image, the display unit 62 performs the conversion of the captured image into the display image having the number of display pixels.

The recording unit 63 records the image signal output from the image processing unit 61 into the recording medium.

The recording medium may be a removable one such as a memory card, an optical disc, and a magnetic tape, or may be fixed type hard disc drive (HDD) or a semiconductor memory module.

In addition, by providing an encoder and a decoder in the recording unit 63, and performing a decompression decoding and compression encoding on the image signal, and then the encoded signal may be recorded in the recording medium. Moreover, in the recording unit 63, the image signal or the encoded signal recorded in the recording medium is read out and then the recorded image may be displayed on the display unit 62.

The user interface (user I/F) unit 64 is configured to include the zooming lever and the shooting button. The user interface (user I/F) unit 64 generates the operation signal according to the user operation, and outputs the signal to the control unit 65.

The control unit 65 includes, for example, the central processing unit (CPU), the read only memory (ROM), and the random access memory (RAM). The CPU reads out and executes the control program stored in the ROM according to the necessity. In the ROM, the program executed in the CPU, various data necessary for various processes are stored in advance. The RAM is a memory used as a so-called work area where an interim result of the processing is temporarily stored. In addition, in the ROM or the RAM, various control information or correction data are stored. The control unit 65 performs the controlling of each unit according to the operation signal from the user interface (user I/F) unit 64, and causes the operation according to the user operation to be performed in the imaging device 10.

In the imaging device 10a configured like this, even when the motion information is delayed due to the time necessary for calculating the amount of shake by the motion detection unit 25, the correction control unit 30 performs the shake correction considering the delay as described above. Therefore, even in the imaging device using the motion detection sensor, it is possible to improve the performance of the shake correction.

Furthermore, in the first embodiment and the second embodiment, the case is described, in which the time difference between the motion detection and the acquisition of the captured image is one frame. However, the reverse correction can be prevented by reducing the time difference.

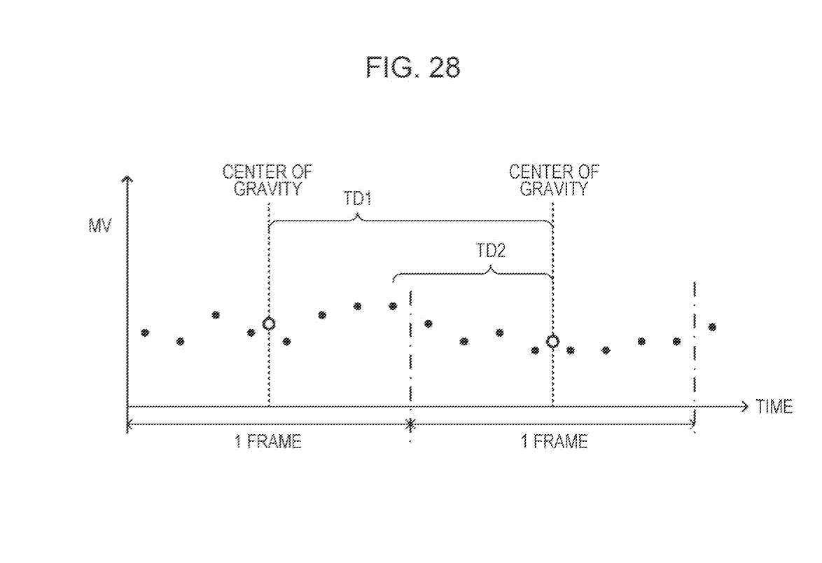

For example, by obtaining a motion vector (black dots) for each slice in one frame, in a case where a global motion vector (white dots) of the image of one frame is obtained from the motion vector for each slice, the center of gravity is on the middle position in the period of one frame as illustrated in FIG. 28. In addition, since the global motion vector of the image of one frame from the motion vector for each slice in one frame is obtained, a delay of one frame period occurs. However, if the motion vector of the slice positioned at the end of the frame period is used as the motion detection vector, the time difference between the image in which the motion correction is performed and the motion detection can be reduced, and it is possible to prevent the reverse correction.

Furthermore, in case of performing an electronic type of shake correction, the imaging device uses an image from a partial region of the imaging element as the captured image. Therefore, if the motion vector of the image from the region where the reading out order is earlier than the region of the captured image, is calculated and used as the motion detection vector, it is possible to further reduce the time difference.

In addition, in suppressing the reverse correction, it is possible to increase the sampling frequency. For example, as described in “1. Regarding deterioration of motion correction performance”, when the frame rate of the captured image is 30 frames/second and the time difference between the motion detection and the acquisition of captured image is one frame period, if the shake frequency is so high as to exceed 5 Hz, the reverse correction occurs. However, if the frame rate (which corresponds to the shake frequency) of the captured image is increased, since the corrected amplitude amplification rate after the shake correction in Equation (2) decreases, even the shake frequency becomes higher than 5 Hz, it is possible to prevent the reverse correction from occurring. Therefore, in the imaging device, in a case where the frame rate (which corresponds to the sampling frequency) of the captured image is switchable, by increasing the frame rate, it is possible to make the reverse correction hardly occur.

In addition, in the embodiment described above, the case is described in which the shake correction of the captured image is performed as the motion correction. However, a focal plane distortion correction may be performed by the imaging device to which the information processing device with the present technology is applied.

In a case where a focal plane shutter type complementary metal oxide semiconductor (CMOS) image sensor is used as the imaging element, data for each line can be transferred in the image sensor. Therefore, when the camera shake of the imaging device occurs in the frame due to the time delay of the imaging timing in the frame, so-called focal plane distortion occurs on the subject. Therefore, in the imaging device, if the shake correction for each frame described above is performed for each line, the reverse correction can be prevented, and the focal plane distortion can be corrected with high accuracy.

In addition, the present technology is also applicable to a case where motion correction of the display position is performed such that a desired face or an object can be displayed on a predetermined position of the image by recognizing the desired face or the object, and by causing the display region to move based on the motion detection result of the desired face and the object. For example, using an object detection unit instead of the motion detection unit in FIG. 4, the recognition and the motion detection of the desired face or the object are performed. In the object detection unit, time is necessary for the processing, and in a case where the time difference between the processing result and the image on which the motion correction is performed is large, as described above, the corrected motion information which performs the suppression processing and the motion prediction is generated. Furthermore, by performing the motion correction based on the corrected motion information, the motion correction of the display position can be performed with high accuracy such that the desired face or the object is displayed on the predetermined position on the image, while preventing the reverse correction. Furthermore, even without having to memorize the image corresponding to the processing time necessary for recognizing the face or the object and for the motion detection such that processing result and the image on which the motion correction is performed are synchronized, since the correction of the display position can be performed with high accuracy while preventing the reverse correction, the use of memory can be lowered.

In addition, in case of moving an image displayed on a head mounted display according to the moving or facing direction of a person, there may be a problem that the time difference between the detection result and the image on which the motion correction is performed becomes large due to the time necessary for detection of the moving or direction. In this case, the corrected motion information which performs the suppression processing and the motion prediction is generated, and then the motion correction is performed based on the corrected motion information. In this way, the motion correction of the display position such that the image is displayed according to the moving or facing direction of the person can be performed with high accuracy with preventing the reverse correction. In addition, it is possible to minimize the memory size as described above.

Furthermore, a series of processing described in the specification can be executed by hardware, software, or by a combined configuration of both. In case of executing the processing by software, a program in which the processing sequence is recorded is installed in a memory in a computer incorporated in the dedicated hardware, to be executed. Alternatively, the program can be installed in the general-purpose computer which is capable of performing various processings, to be executed.

For example, the program can be recorded in a recording medium such as a hard disc or a read only memory (ROM) in advance. The program can be stored (recorded) temporarily or permanently in the removable recording medium such as a flexible disc, a compact disc read only memory (CD-ROM), a magneto optical disc (MO), a digital versatile disc (DVD), a magnetic disc, or a semiconductor memory card. The removable recording medium like this can be supplied as so-called package software.

In addition, other than being installed in the computer from the removable recording medium, the program may be transmitted to the computer by wires or wirelessly from the download site via a network such as local area network (LAN) or internet. In the computer, the program transmitted in this way is received, can be installed to the embedded recording medium such as a hard disc.

Moreover, the present technology is not construed as being limited to the embodiments described above. The embodiments of the present technology disclose the present technology in a form of examples, and it is apparent that those skilled in the art can make modifications and substitutions of the embodiments without departing from the scope of the present technology. That is, in order to determine the gist of present technology, the Claims attached hereto should be referred to.

In addition, the information processing device of the present technology may have a configuration as follows.

(1) An information processing device including: an amplification detection unit that detects an amplification of a motion of an image in a motion correction with respect to the motion of the image generated by the motion, according to motion information which indicates a motion detection result and a frame rate of the image; and an information suppressing unit that suppresses the motion indicated by the motion information based on the detection result of the amplification detection unit such that the motion of the image is not amplified in the motion correction, and generates corrected motion information used in the motion correction.

(2) The information processing device according to above (1), further including: a filter that performs removing of a component which amplifies the motion of the image in the motion correction by the motion information, wherein the information suppressing unit generates corrected motion information which performs the motion suppression with respect to the filtering processed-motion information.

(3) The information processing device according to above (1) or (2), wherein the amplification detection unit calculates a stability rate which indicates a proportion of the component which does not amplifies the motion of the image in the motion correction, and converts the stability rate to the correction rate of the motion information, and wherein the information suppression unit performs the suppression of the motion indicated by the motion information based on the correction rate.

(4) The information processing device according to above (3), wherein the amplification detection unit calculates the stability rate based on the motion information corresponding to a predetermined number of frames and the component which amplifies the motion of the image extracted from the motion information or the component which does not amplify the motion of the image.

(5) The information processing device according to above (3) or (4), wherein the amplification detection unit switches the correction characteristics of the motion correction by switching the conversion characteristics in which the stability rate is converted to the correction rate.

(6) The information processing device according to above (5), wherein, in a case where the amplification suppression of the motion of the image is emphasized in the motion correction, the amplification detection unit sets the conversion characteristics such that, in the interval where the stability rate is low, the correction rate interval in which the state where the shake correction is not performed is longer than that in a case where the correction accuracy is emphasized.

(7) The information processing device according to above (1) to (6), further including: a motion prediction unit that performs a motion prediction using the motion information to generate motion prediction information; and a selection processing unit that uses the motion prediction information as the corrected motion information in a case where a prediction error of the motion prediction information is smaller than the threshold value set in advance, and uses a suppressed motion information of the motion as the corrected motion information in a case where a prediction error of the motion prediction information is equal to or larger than the threshold value set in advance.

(8) The information processing device according to above (7), wherein the motion prediction unit performs the motion prediction for each of a plurality of different prediction models to generate the motion prediction information, and wherein the selection processing unit uses the motion prediction information obtained by using a prediction model having the minimum prediction error as the corrected motion information, in a case where a minimum prediction error in the plurality of different prediction models is smaller than the threshold value set in advance.

(9) The information processing device according to above (1) to (8), further including: a motion detection unit that generates the motion information, wherein the motion detection unit reduces a time difference between the image in which the motion correction is performed and a motion detection by generating the motion information using a part of the image.

What is claimed is:

1. An information processing device comprising:
an amplification detection unit that detects an amplification of a motion of an image in a motion correction with respect to the motion of the image generated by the motion, according to motion information which indicates a motion detection result and a frame rate of the image; and
an information suppressing unit that suppresses the motion indicated by the motion information based on the detection result of the amplification detection unit such that the motion of the image is not amplified in the motion correction, and generates corrected motion information used in the motion correction.

2. The information processing device according to claim 1, further comprising:
a filter that performs removing of a component which amplifies the motion of the image in the motion correction by the motion information,
wherein the information suppressing unit generates corrected motion information which performs the motion suppression with respect to the filtering processed motion information.

3. The information processing device according to claim 1,
wherein the amplification detection unit calculates a stability rate which indicates a proportion of the component which does not amplifies the motion of the image in the motion correction, and converts the stability rate to the correction rate of the motion information, and
wherein the information suppression unit performs the suppression of the motion indicated by the motion information based on the correction rate.

4. The information processing device according to claim 3,
wherein the amplification detection unit calculates the stability rate based on the motion information corresponding to a predetermined number of frames and the component which amplifies the motion of the image extracted from the motion information or the component which does not amplify the motion of the image.

5. The information processing device according to claim 3,
wherein the amplification detection unit switches the correction characteristics of the motion correction by switching the conversion characteristics in which the stability rate is converted to the correction rate.

6. The information processing device according to claim 5,
wherein, in a case where the amplification suppression of the motion of the image is emphasized in the motion correction, the amplification detection unit sets the conversion characteristics such that, in the interval where the stability rate is low, the correction rate interval in which the state where the shake correction is not performed is longer than that in a case where the correction accuracy is emphasized.

7. The information processing device according to claim 1, further comprising:
a motion prediction unit that performs a motion prediction using the motion information to generate motion prediction information; and
a selection processing unit that uses the motion prediction information as the corrected motion information in a case where a prediction error of the motion prediction information is smaller than the threshold value set in advance, and uses a suppressed motion information of the motion as the corrected motion information in a case where a prediction error of the motion prediction information is equal to or larger than the threshold value set in advance.

8. The information processing device according to claim 7,
wherein the motion prediction unit performs the motion prediction for each of a plurality of different prediction models to generate the motion prediction information, and
wherein the selection processing unit uses the motion prediction information obtained by using a prediction model having the minimum prediction error as the corrected motion information, in a case where a minimum prediction error in the plurality of different prediction models is smaller than the threshold value set in advance.

9. The information processing device according to claim 1, further comprising:
a motion detection unit that generates the motion information,
wherein the motion detection unit reduces a time difference between the image in which the motion correction is performed and a motion detection by generating the motion information using a part of the image.

10. An information processing method comprising:
detecting an amplification of a motion of an image in a motion correction with respect to the motion of the image generated by the motion, according to motion information which indicates a motion detection result and a frame rate of the image; and
suppressing the motion indicated by the motion information based on the detection result such that the motion of the image is not amplified in the motion correction and generating corrected motion information used in the motion correction.

11. An imaging device comprising:
an imaging unit that generates an image signal of a captured image;
a motion detection unit detects the motion of the device and generates motion information;
an amplification detection unit that detects an amplification of a motion of an image in a motion correction with respect to the motion of the image generated by the motion of the device, according to motion information and a frame rate of the image;
an information suppressing unit that suppresses the motion indicated by the motion information based on the detection result of the amplification detection unit such that the motion of the image is not amplified in the motion correction, and generates corrected motion information used in the motion correction; and
a correction unit that performs the motion correction of the captured image based on the corrected motion information generated by the information suppressing unit.
